(19) United States
(12) Patent Application Publication
(10) Pub. No.: US 2012/0330759 A1
(43) Pub. Date: Dec. 27, 2012

(54) ENERGY SYSTEMS

(76) Inventors: Vikram Aggarwal, Brookline, MA (US); James G. Biggar, Cambridge, MA (US); Joseph G. Larusso, Roslindale, MA (US)

(21) Appl. No.: 13/494,649

(22) Filed: Jun. 12, 2012

Related U.S. Application Data
(60) Provisional application No. 61/496,029, filed on Jun. 12, 2011.

(51) Int. Cl. G06Q 30/00; G06F 3/01; G06Q 30/02

(52) U.S. Cl. 705/14.73; 705/26.2; 705/27.1; 715/733

(57) ABSTRACT

Among other things, an online interface is provided in which a property owner enters information defining a specification of an intended energy system to be installed for the property owner. The specification is in sufficient detail to enable each of two or more different installers to provide commercial offers of an energy system that conforms to the specification. An online interface may be provided in which a property owner is presented with a guided sequence of interactive steps in which the property owner is prompted to enter information associated with energy systems that may be relevant to the property owner, the content of at least one of the later steps being dependent on the information entered by the user in a prior step. A selection of energy systems based on technical feasibility and suitability as determined from information provided by the property owner may be presented through the interface.

### CROSS-REFERENCE TO RELATED APPLICATION

This patent application claims priority to U.S. Provisional Application No. 61/496,029, which was filed on Jun. 12, 2011. U.S. Provisional Application No. 61/496,029 is hereby incorporated by reference into this patent application as if set forth herein in full.

### TECHNICAL FIELD

The present disclosure relates to energy systems.

### BACKGROUND

Energy systems, including but not limited to distributed clean energy (DCE) technologies (e.g., solar photovoltaic (PV), solar thermal, solar heating, solar air-conditioning, wind turbine systems, biofuel) and high-efficiency HVAC and hot water systems (e.g., combined heat and power (CHP), geothermal, air-source heat pumps), are not universally or uniformly suitable for all properties. For example, a wind turbine may be unsuitable for the home of an urban-dwelling consumer, but may be a suitable technology for another consumer who is not subject to strict zoning restrictions. A solar photovoltaic array or solar thermal system may not be suitable for a residential consumer who does not own a home with a flat or a south-facing roof, and who lacks sufficient land to mount those systems on the ground, but that same consumer may benefit from a combined heat and power system. Still another consumer may find that her home is suitable for a solar photovoltaic system, a solar thermal system, and a combined heat and power system, but she only wishes to purchase the energy systems that will save her the most money. Her next-door neighbor may find that his home too is suitable for a solar photovoltaic system, a solar thermal system, and a combined heat and power system, but he wishes to purchase the energy systems that will emit the least amount of greenhouse gases into the environment. Energy systems are thus not universally, or uniformly suitable for all consumers because of differences in the attributes of their individual homes and businesses, differences in the profiles of their energy consumption (electricity, natural gas, heating oil, etc.), and differences in their individual consumer preferences, among other things.

### SUMMARY

This specification describes technologies relating, for example, to facilitating the selection or acquisition or both of energy systems for deployment on land and/or fixed or mobile structures, such as houses, apartment buildings, office buildings, and other residential and commercial structures, to name a few.

In general, in an aspect, an online interface is provided in which a property owner enters information defining a specification of an intended energy system to be installed for the property owner. The specification is in sufficient detail to enable each of two or more different installers to provide commercial offers of an energy system that conforms to the specification.

Implementations may include one or more of the following features. Defining a specification of an intended energy system includes defining parameters relating to and attributes of a property of the property owner. The commercial offers comprise offers in a form ready for acceptance. The specification includes information identifying a location of the property, property characteristics, types of energy systems, consumption of energy at the property, and a cost of operating existing energy systems. Through the online interface, the property owner can enter into a commercial transaction for one of the energy systems by accepting the commercial offer for the energy system. The property owner is prompted in the online interface for each one of a set of specific items of information that together will be sufficient to define the specification. Copies of the same defined specification are electronically transmitted to two or more different installers to solicit ready-for-acceptance offers from them for energy systems that conform to the specification. The offers are in a form ready for acceptance. Through the online interface installers may solicit additional information from the property owner prior to providing their commercial offers. The received ready-for-acceptance commercial offers include parameters of the offers. These parameters include pricing based on financing options. The offers including the parameters are presented to the property owner through the online interface. The online interface includes a dashboard that gives access to information about the intended energy system, the specification, the installers, and the commercial offers. The online interface enables the property owner to communicate using text, images, video, or documents with one or more of the installers. The online interface enables the property owner to define preferences with respect to the commercial offers. The preferences include a limit on the number of commercial offers to be permitted for the specification. The online interface provides information that suggests relative desirability for the property owner of two or more of the commercial offers or of the installers or of both. The online interface provides ratings and reviews of installers, marketing information provided by the installers, and information about the energy equipment the installer proposes to install. The online interface enables the property owner to share with others a case study based on the specification and other information related to the intended energy system. The information defining a specification includes information derived from the property owner by a guided sequence of interactive steps in which the property owner is prompted to enter information associated with energy systems of interest to the property owner, the content of at least one of the later steps being dependent on the information entered by the user in a prior step. The online interface is provided through a mobile application or a website.

In general, in an aspect, an online interface is provided that presents to a property owner parameters defining two or more ready-to-accept offers, each to install an energy system that conforms to a common specification of an energy system.

Implementations may include one or more of the following features. The parameters of the offers are expressed in common comparable units. The common comparable units include standardized metrics for energy systems. The online interface enables the property owner to compare the two or more offers using the common comparable units. The online interface enables the property owner to express or change assumptions that underlie the two or more offers and to have the expressed or changed assumptions applied automatically to all of the two or more offers to produce altered offers that can be compared based on the common comparable units. The interface presents the parameters defining the two or more offers simultaneously to the property owner.

In general, in an aspect, an online interface is provided that presents to a property owner interactive tools that enable the property owner to compare or rank two or more ready-to-accept offers each to install an energy system that conforms to a common specification previously expressed by the property owner.

Implementations may include one or more of the following features. The two or more offers are expressed in common comparable units. The two or more offers are presented simultaneously for comparison or ranking. The property owner can select one or more criteria with respect to which the two or more offers are to be compared or ranked.

In general, in an aspect, potential installers of energy systems are provided an online interface that enables them to submit information to be stored at a server and presented to property owners in connection with the property owners engaging in purchase transactions for installations of energy systems.

Implementations may include one or more of the following features. The online interface includes a dashboard that gives to each of the installers access to information about the energy systems, the purchase transactions, and the property owners. The online interface enables the potential installers to communicate with the property owners using text, images, video, or documents. The online interface enables installers to reserve one of a limited number of potential opportunities to provide commercial offers with respect to a purchase transaction to be engaged in by a property owner. The online interface enables installers to specify parameters of potential purchase transactions for which they wish to be notified for consideration. The information includes marketing information of the installers. The online interface enables installers to submit contracts for electronic signatures by the property owners. The online interface is provided through a mobile application or a website.

In general, in an aspect, an online interface is provided in which a property owner enters information defining a specification of an intended energy system to be installed for the property owner. The specification is in sufficient detail to enable each of two or more different installers to provide ready-for-acceptance commercial offers of an energy system that conforms to the specification.

Implementations may include one or more of the following features. Through the online interface parameters are presented to the property owner defining the two or more ready-to-accept offers each to install an energy system that conforms to a common specification of an energy system. The parameters of the offers are expressed in common comparable units. Through the online interface, interactive tools are presented to the property owner that enable the property owner to compare or rank the two or more ready-to-accept offers each to install an energy system that conforms to a common specification previously expressed by the property owner. In connection with the property owners engaging in purchase transactions for installations of energy systems, marketing information of installers is presented that has been entered through a different online interface.

In general, in an aspect, an online interface is presented in which a property owner is presented with a guided sequence of interactive steps in each of which the property owner is prompted to enter information associated with energy systems that may be relevant to the property owner. The content of at least one of the later steps is dependent on the information entered by the user in a prior step. Implementations may include one or more of the following features. The information to be entered comprises information associated with at least one energy-related objective of the property owner, the attributes of the property, an existing energy system, and an existing cost of energy. The information to be entered by the property owner includes information that bears on the suitability of energy systems for the property owner or a property to be served by the energy system. The information to be entered by the property owner includes characteristics of a property to be served by the energy systems. The information to be entered by the property owner comprises characteristics of existing energy systems of the property owner. The information to be entered by the property owner includes characteristics of energy usage associated with the property owner or a property to be served by the energy systems. The information to be entered by the property owner includes characteristics of energy systems currently in use at the property. The information to be entered by the property owner includes information that represents criteria for selecting one or more energy systems from a set of energy systems. An indication of a technical feasibility of one or more energy systems for a property associated with the property owner is presented to the property owner based on the information entered by the property owner. An indication of a suitability of one or more energy systems for a property associated with the property owner is presented to the property owner based on the information entered by the property owner. Information provided by the property owner is used for online solicitation of commercial offers by installers for energy systems identified as technically feasible and suitable for a property associated with the property owner.

In general, in an aspect, through an online interface results of a selection of energy systems from a set of possible energy systems is presented to a property owner based on technical feasibility and suitability as indicated by information provided by the property owner through the interface in response to a series of prompts the content of some of which depend on information provided with respect to prior prompts.

Particular embodiments of the invention can be implemented to realize none, one or more of the following advantages. Some implementations may facilitate comparison and evaluation of energy systems quotes from pre-screened installers on a uniform basis. Some implementations may simplify the research and purchase process for energy systems. Some implementations may enable determination of which energy systems are suitable for a particular property. Some implementations may result in lower prices for consumers of energy systems. Some implementations may reduce customer acquisition costs for energy systems installers. Some implementations may automate and speed open-market interactions between property owners and energy systems installers.

These and other features, aspects, and implementations can be expressed as apparatus, components, program products, systems, methods, methods of doing business, and means or steps for performing functions, and combinations of them.

Other features, aspects, implementations, and advantages will become apparent from the description, the drawings, and the claims.

### BRIEF DESCRIPTION OF THE DRAWINGS

FIG. 1 is a summary schematic view of the energy system wizard.

FIG. 2 is a detailed schematic view of the energy system wizard.

FIG. 3 is a schematic view of the algorithm used to calculate the weighted average of values assigned to consumer responses to questions regarding the attributes of their properties, their energy consumption (electricity, natural gas, heating oil, etc.), and their individual consumer preferences.

FIG. 4 is a table showing example numerical values assigned to consumer responses to questions regarding the attributes of their homes and businesses, their energy consumption (electricity, natural gas, heating oil, etc.), and their individual consumer preferences.

FIGS. 5A-5M are diagrams of example user interfaces presented to a property owner to facilitate purchase of an energy system for a property.

FIGS. 6A-6L are diagrams of an example user interface for an installer.

FIGS. 7A-7D are diagrams of an example installer dashboard.

FIGS. 8A-8F are diagrams of an example platform administrator dashboard.

FIGS. 9A-9B are diagrams of an example property owner dashboard.

FIGS. 10A-10E are diagrams of example communications exchanged between a property owner and installers.

FIG. 11 is a block diagram of an example online environment including a platform that is used to implement some of the techniques described here.

FIG. 12 is a flow chart for an example process for facilitating purchases of energy systems for properties.

FIG. 13 shows an example of a computer device and a mobile computer device that can be used to implement the techniques described here.

### DETAILED DESCRIPTION

The systems and methods described here provide residential and commercial property owners with information, education, resources, guidance, and analytical tools to research, select, and purchase energy systems. Examples of energy systems include, but are not limited to, distributed clean energy (DCE) systems and high-efficiency HVAC and hot water systems. Examples of DCE systems include, but are not limited to, solar photovoltaic systems, solar thermal systems (e.g., for heating water, space heating, space air-conditioning), wind systems, biomass, and biofuel systems. Examples of high-efficiency HVAC and hot water systems include, but are not limited to combined heat and power systems, geothermal and air-source heat pumps). When we use the term energy systems, we use it in a very broad sense to include for example every possible kind of hardware, mechanical, electrical, software, firmware, and other that is associated with the production, use, delivery, conservation, storage, conversion, sale, purchase, or any other aspect of the use of energy in any form for any purpose. We sometimes use the phrase type of energy system to refer broadly, for example, to any category, class, grouping, style, manufacturer, model, configuration, size, use, functionality or other categorization feature of energy systems.

In some implementations, an online platform allows and enables property owners and their representatives to solicit and evaluate competing quotes from installers, contractors, manufacturers, financiers, builders and other professional suppliers (collectively referenced here as installers) selling suitable energy systems. In some examples, these installers may be pre-screened by a platform administrator and approved to participate in the solicitation process. The platform allows installers to submit quotes in response to a property owner's solicitation for quotes and it allows property owners to designate winning quotes and purchase energy systems and/or services from the winning installers. We use the phrase online platform in a very broad sense to include, for example, any possible online, electronic, networked, portable, mobile, or other system that is accessible to users and provides features with which they can interact. Also, we sometimes use the term quote interchangeably with the phrase commercial offer and the phrase bid and we use those terms broadly to include, for example, any sort of communication by which one party expresses to the other an offer to enter into a commercial transaction under identified terms.

The platform may allow partner organizations to promote programs for their members and employees encouraging them to install energy systems on their properties. Partner organizations could include non-profits, non-government organizations, and for-profit organizations, for example.

In some implementations, the platform includes a primary public system that is publicly accessible through a communication network such as the Internet or a mobile telephone network, for example. The platform may provide multiple independent marketplaces or sandboxes. Each sandbox may have, e.g., unique, rules specifying which property owners and installers may participate and on what terms. For example, a sandbox may be provisioned to support a certain municipality's clean energy program, which is open only to residents of that municipality and installers based in the same state. In some implementations, a sandbox may be open to all installers, but in-state installers are granted privileged access, such as early notification that a new solicitation for quotes has been submitted. Access to sandboxes may be controlled by administrator intervention or by a pre-shared access or program code.

The platform may be hosted on the Internet and accessed via desktop and laptop computers, and other mobile devices including smartphones and tablets via a browser and/or custom applications (e.g., so-called mobile apps). The platform may be optimized for access via mobile devices.

We use the terms property owner or PO very broadly to refer, for example, to any individual, family, household, company, organization, or other legal entity of any kind that has any kind of a right or interest to investigate, select, and have installed on property associated with the property owner any kind of an energy system. These terms are not limited to literal owners of property, but extend to owners, renters, lessees, agents, brokers, developers, sellers, buyers, renovators, financers, mortgagors, mortgagees, and any other party who have an interest or relationship to a property. We use the term property in the broadest possible sense to include, for example, any kind of real property, such as land, fixed or mobile structures (e.g., buildings, mobile homes, or house boats), and fixtures, among other things. We use the term installer broadly to include, for example, any party who can or will sell, deliver, install, construct, build, or otherwise make available to another party a system, for example when energy system.

The platform, for example, may streamline a solar photovoltaic (PV) purchase process and lower the cost of solar PV installed systems. In just a few minutes, a PO may use the platform to solicit multiple quotes from a long list of pre-screened, high-quality installers. The quotes may be displayed in a standardized format that allows POs to evaluate and compare them to select the best option, fostering price transparency and competition. POs may gain confidence in their purchase decisions through a suite of educational, analytical, and comparison-shopping tools—all provided, in some implementations, in an integrated online interface (e.g., a web site or mobile app).

The platform may provide a suite of tools that may include an interactive tool for identifying energy systems that are suitable for a particular property. This interactive tool may be referred to as an energy system wizard. U.S. Provisional Application No. 61/496,029 describes example energy system wizards and is incorporated here by reference in its entirety.

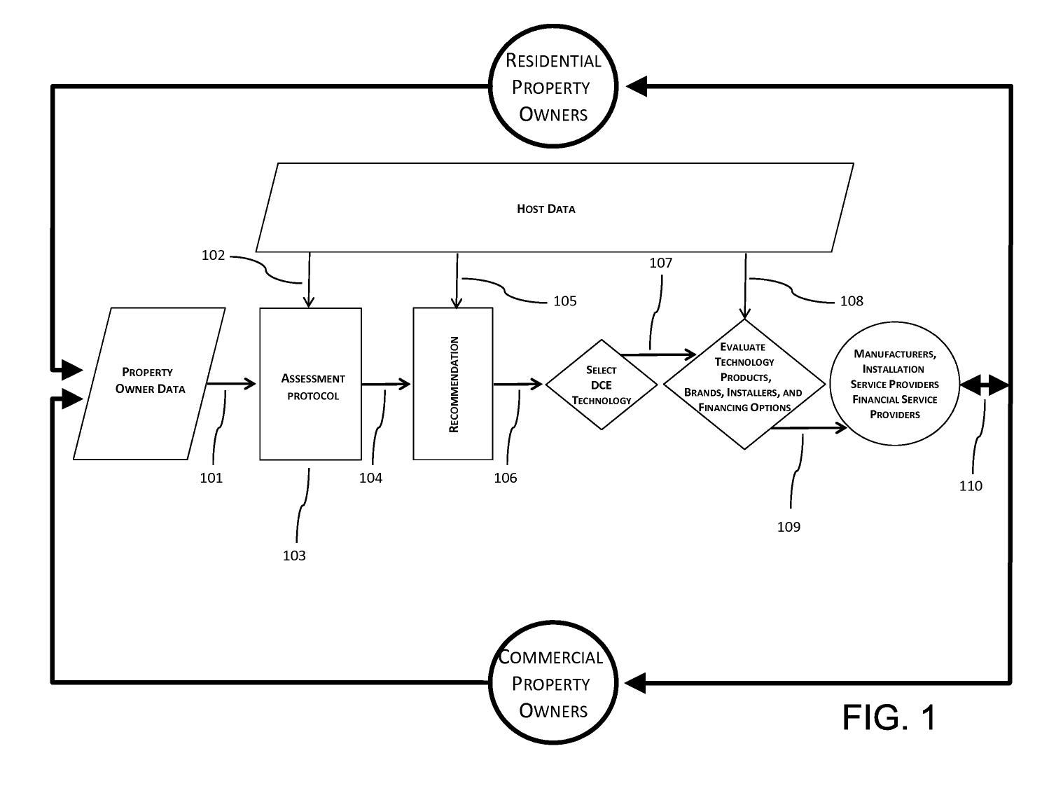

Referring now to FIG. 1, an example process for energy system selection is shown. Although the examples described in relation to FIGS. 1-4, refer to selection of a DCE system, the discussion and figures also apply to the selection of a broad range of other types of energy systems. The process can commence when data from property owners regarding their homes and businesses or other properties, the pattern of their energy consumption, their goals and objectives, and themselves, is inputted 101 in response to the queries that constitute the assessment protocol 103, e.g., the wizard.

The data provided by property owners is supplemented with data provided by the host of the system regarding the suitability of DCE technology types in certain circumstances and subject to certain conditions 102. The host is an administrator of the energy system wizard tool described in relation to FIGS. 1-4. We sometimes use the word host and the word administrator interchangeably.

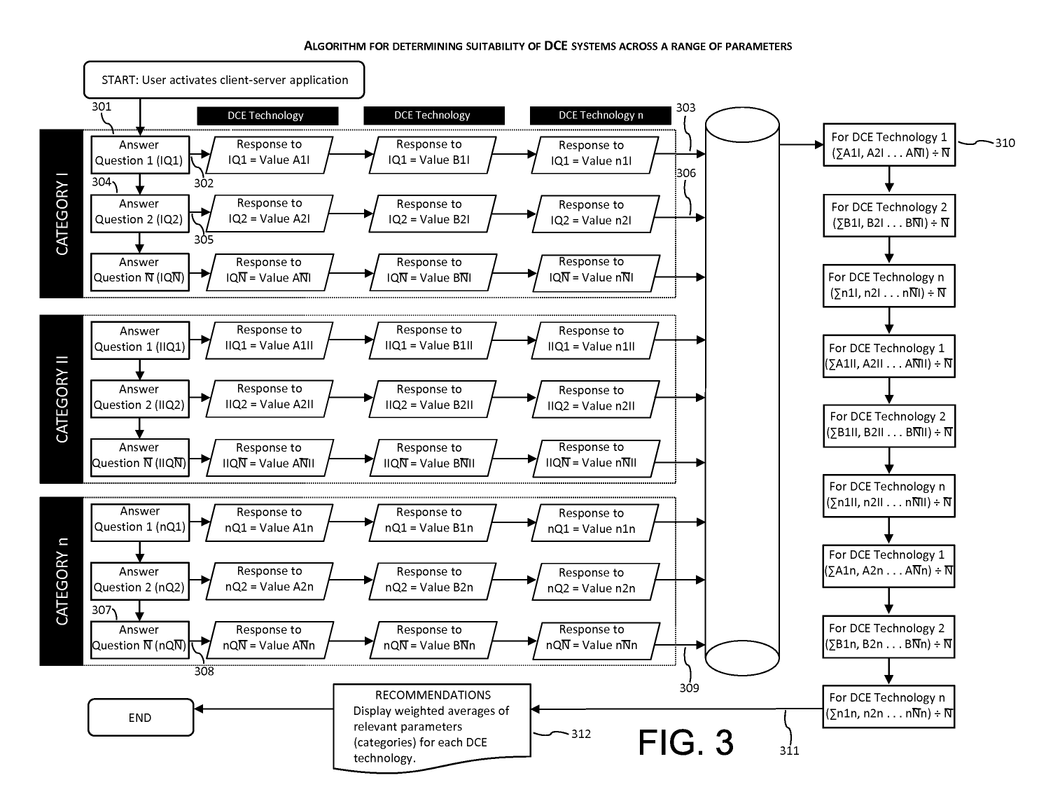

The data provided by property owners 101 and the host of the system 102 is then analyzed by weighting the data from these two sources according to a proprietary algorithm developed by the host of the system 103. (For more information regarding the algorithm employed by the assessment protocol see FIG. 3 and the corresponding detailed description in this section, below.)

The result of this weighted analysis 104 is a recommendation that ranks the relative suitability of the plurality of DCE system types taking into account, among other possible criteria, their acquisition costs, the annual savings that the installed systems are anticipated to yield; the ROI that the installed systems are anticipated to produce, as well as the comparative environmental benefits of the systems measured in terms of the carbon emissions they offset.

This recommendation concerning the plurality of DCE systems is complemented by additional resources and data provided by the host of the system that enable property owners to better evaluate the financial benefits of suitable systems 105. Those resources may include, but are not limited to, portfolio analysis tools, financial analysis tools, and case studies regarding similar installed systems.

Based on the recommendation, property owners are then equipped to determine which type of DCE technology or system represents the best DCE solution for their property based on their goals 106.

Once property owners have determined which type of DCE technology represents the best solution for them, property owners are then provided with resources by the host of the system that allow them to evaluate brands of DCE systems, products, and installers, and lenders and other financial service providers 107 and (as explained below) to solicit and choose offers for such systems.

In some implementations, this evaluation is also facilitated with data and information provided by the host of the system that include, but are not limited to, customer reviews, specifications, system performance statistics, term sheets, case studies, and profiles 108.

Once property owners have completed their evaluation of types of DCE systems, brands of DCE technologies, DCE products, and professional and financial services, they then can identify the manufacturers and service providers that they wish to contact using a database provided by the host of the system 109.

In some implementations, after the host of the system has conveyed property owners' requests for products and professional and financial services professionals to those manufacturers, installers, and professionals, the manufacturers, installers, and professionals will have the opportunity to solicit additional information from property owners in order to confirm their requests. For this reason the host of the system also provides customer relationship management support to product manufacturers, installers, and financial product/service providers while they exchange information with property owners 110.

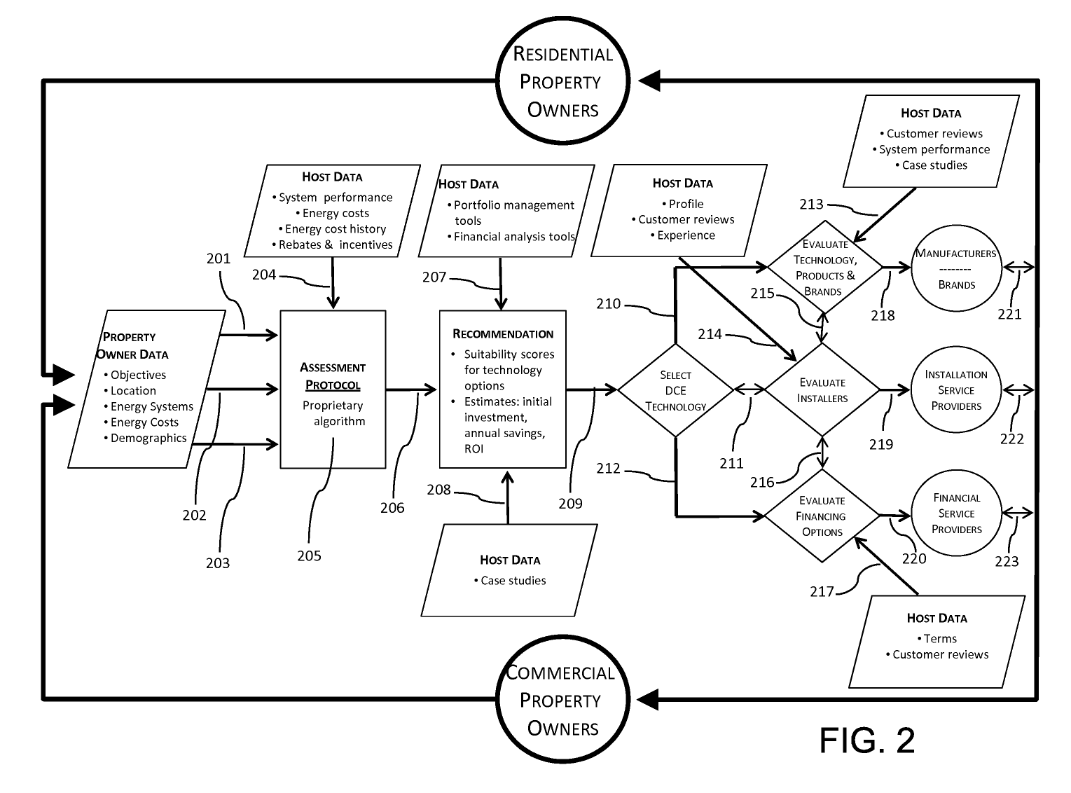

In FIG. 2 there is shown a system by which property owners evaluate the suitability of a plurality of DCE technologies and system types for their homes and businesses, including, in some examples, the use of one of three alternative modes to complete such evaluation; the presentation to property owners of a comprehensive, personalized assessment of DCE technologies; the utilization of that assessment to facilitate the selection by property owners of DCE products and installation services; the publication of information regarding the range of financial products that are available to finance DCE systems; the resources made available to property owners to enable them to procure products and installation and financial services by transmitting their requests directly to product and service providers including installers; and the resources made available to product and service providers so that they may receive, schedule, and act upon property owner requests.

The system is initiated when property owners input data regarding their homes and businesses (we use the phrase homes and businesses to refer very broadly to any kind of property that is the subject of an energy system), the pattern of their energy consumption, their goals and objectives, and themselves, using a multi-step assessment protocol. This is accomplished via a series of customized questions used to gather the information that is necessary to provide property owners with a personalized, comparative assessment of DCE technologies. The customized questions thus represent a protocol and therefore represent a so-called wizard: they are used to acquire required data which is then paired with additional data provided by the host of the system, and then weighted using a proprietary algorithm to score each DCE technology with respect to, in one embodiment, its suitability, its acquisition cost, the annual savings that it is anticipated to yield, the ROI that it is anticipated to produce, as well as its comparative environmental benefit measured in terms of offset carbon emissions.

The customized questions are arranged and presented in separate categories that may include, but are not limited to questions regarding the property owners' goals, the attributes of their properties, their current energy systems, and demographic information. The questions can be presented in a sequence such that the content of later questions depends on interest of the earlier questions.

For example, users may first be asked “What are your primary goals?” and be presented with five possible responses to this question: “Have more money to spend on my favorite things”; “Better resale value for my property”; “Reduce my impact on the environment”; “Support U.S. energy independence”; and “Support green jobs.” In this example, property owners may select one or more of the above responses by checking a box that is adjacent to the response. In some cases, however, checking a box may require property owners to further elaborate upon their response. In this example, if a property Owner selects “Have more money to spend on my favorite things” they may then be asked if they wish to (i) “lower/eliminate energy costs” with respect to electricity, heating their home, cooling their home, or hot water (including pool heating) or (ii) whether they wish to “lock in long-term energy costs” again with respect to electricity, heating their home, cooling their home, or hot water (including pool heating). In this example property owners may then be asked the size of their properties measured in square feet, whether their roof is flat or sloping, the age of their roof, whether their roof is free of shade, partially shaded or completely shaded, whether or not they have a yard, their lot size, whether they have a basement or a utility room, whether they have a natural gas or propane connection, whether they have a pool, and whether or not they live in a windy location.

In this example, under the heading “Property,” property owners may be asked to input information regarding their homes or businesses that may include, but is not limited to, their postal codes, whether they own or rent, whether they live in an urban, suburban or rural community, whether they live in a single or a multi-family home, and the number of people in their household.

In this example property owners may further be asked questions regarding their current energy systems that may include, but are not limited to, whether they have a forced air, baseboard/forced hot water, steam or radiant home heating system, and the age of their existing heating system. In this example, property owners may also be asked whether they have air conditioning systems and, if so, the age of their system and whether it is a central air conditioning system or a unitary system (i.e. a window air conditioner). Under the same heading property owners may also be asked how much they pay annually for electricity, home heating (i.e. for gas, oil, electric), how much they pay annually for air conditioning, and how much they pay to heat water (i.e. for gas, oil, electric).

Finally, in this example, property owners may also be asked to provide demographic information that includes, but is not limited to, their gender, their age, their occupation, and whether they already own a DCE system.

In addition, the host may employ third party databases as a means to automatically source information that would otherwise be provided by users in response to customized questions.

The responses to the customized questions are inputs that may be delivered to the assessment protocol in one of three ways. First, property owners may input the data (responses) into the assessment protocol themselves 201. The application prompts property owners for each response, and further prompts them if they fail to include any of the required inputs. Second, property owners may request and receive curated assistance from the host of the system via telephone or online “chat” 202. Property owners who use seek this assistance will still input the data themselves, but will do so with the assistance of the host of the system. Finally, property owners may delegate the entire task of entering the inputs to the host of the system 203. The host of the system collects the relevant information from property owners via interviews, and the collected information is entered into the assessment protocol by the host of the system. In some examples, combinations of two or more of the three modes of entry can also be used.

The data that property owners input 201 202, or that the host of the system inputs for them 203 is paired with additional data provided by the host of the system 204, and then weighted using a proprietary algorithm (see FIG. 3) to score DCE technology types with respect to their suitability (taking into account the attributes of the owner's property), their acquisition costs, the annual savings that the installed systems are anticipated to yield; the ROI that that installed systems are anticipated to produce, as well as the comparative environmental benefits of the systems measured in terms of the carbon emissions they offset.

In some implementations, the data provided by the host of the system 204 may include, but is not limited to, fuel systems and energy costs by street address (sourced via U.S. census and property sales records). This data enables the host of the system to take into account the types of conventional energy systems that are installed in the property owner's neighborhood, and to estimate annual fuel costs based on the street address of the property. This data also enables the host of the system to prompt the property owner to validate the information provided by the host's data set. This simplifies the process by which users enter data into the assessment protocol 201 202 203, making the application more “user friendly.”

The data provided by the host of the system 204 may also include historical energy price information. The historical energy price data is used to extrapolate future energy price trends, to estimate the user's future energy expenditures, and to estimate the user's future energy cost savings should they opt to purchase a DCE system. The data also includes a schedule of federal, state and local government tax exemptions and deductions, and other financial incentives such as rebates. This data is used to estimate the net investment cost of DCE systems (i.e. gross cost net of tax exemptions and deductions, and other financial incentives).

Finally, the data provided by the host of the system 204 may also incorporate quantified DCE system performance information to predict the savings that DCE systems are likely to achieve based on their efficiency, rated output, etc.

After the data provided by property owners 201 202 203 has been combined with the hosted data 204, each relevant category of data is then weighted by applying a proprietary algorithm 205 that is incorporated into the assessment protocol. (See FIG. 3.) Taking into account the attributes of a property owner's home or business the assessment protocol employs the proprietary algorithm to determine first which DCE system types are technically feasible.

The algorithm then weights (scores) each type of DCE technology that has been determined to be technically feasible for the Property Owner's home or business 206 across a range of relevant parameters to determine, for example, the suitability of the technically feasible solutions. These include, but are not limited to: the attributes of their homes or businesses (suitability); the relative cost of each type of system (investment); the annual savings that each type of system will produce (annual savings); the ROI that each type of system is likely to produce (ROI); and the comparative environmental benefit associated with each type of system (environmental benefit). Suitability scores are made using a scale of 1-100 points. Each of these parameters is presented in column format, and the various DCE system types are ranked within that column according to the number of points it has received. By clicking on each column header, the Property Owner can see how each DCE system is ranked within each given category. The result of this process is the ordered presentation to the Property Owner of scores that together constitute comparative recommendations for each type of DCE system across a range of relevant categories. This comprehensive, ordered presentation allows the customer to simultaneously evaluate the plurality of DCE technology options.

These ordered recommendations are further supplemented by the host of the system with portfolio management and financial tools 207 that allow property owners to evaluate the impact of an investment in a DCE system. These financial tools may also estimate future debt service payments taking into account different rates of interest and different borrowed amounts, and demonstrate the tax benefits of depreciation for commercial property owners. Property owners may also have at their disposal case studies 208 based on actual DCE system installations in their immediate vicinity. A purpose of these case studies is to validate and verify the information contained in the ordered presentation produced by the assessment protocol, and the financial modeling 207 that is based on those results. These case studies include detailed information concerning the DCE technology selected, the brands of DCE products that were installed, the models of each type of product that were installed, the property characteristics, and the installed system's actual performance.

Taking the inputs 206 207 208 into consideration, property owners are then equipped to determine which type of DCE system(s) represents the best clean energy solution(s) for their property, based on their goals 209. Property owners may make this determination entirely on their own, or in consultation in-person, or over the telephone or via online “chat,” with representatives of the host of the system, or by a combination of two or more of those modes.

Some implementations then enable property owners to select from among specific brands of DCE systems 210, to survey and select specific products 210, and to select installers 211, lenders, and other financial service providers 212. Some implementations also provide property owners with information about the various components that comprise each type of DCE system. A solar photovoltaic system, for example, is comprised of photovoltaic panels, panel mounting systems, one or more inverters, and performance measurement and tracking systems. Property owners are further able to learn about and select from product types for each category of components. Solar photovoltaic panels may be, for example, thin-film panels, poly-crystalline panels, mono-crystalline panels, or building integrated panels. Property owners are equipped by some implementations to independently research manufacturers and brands to select the type of solar panel that is most suitable for their particular property, taking into account their consumer preferences, the rated quality of the manufacturer, the rated performance characteristics of the DCE components for their application, and the attributes of their property, including its geographic location 213.

Some implementations thus encourage property owners to simultaneously evaluate installers 211, 215 based on the DCE technology they have selected, and those who are dealers for the brands they have selected. Property owners take into consideration detailed installer profiles, including information concerning their relevant experience (e.g., number of similar projects completed), staffing, certification, affiliations, and customer reviews 214 to make their selection.

Some implementations also enable property owners to evaluate various financing options 212, 217 including commercial loans, subsidized loans, home equity loans, leases, power purchase agreements, etc. The host of the system provides information 217 concerning the advantages and disadvantages of each of the various types of financing arrangements in order to enable property owners to determine the suitability of each 216. Once a property owner has selected the financing option that they feel is best suited to their needs, he or she may refer to descriptions of the common terms and conditions associated with that type of financing. Property owners may also refer to hosted profiles for the financial service providers that offer the financing option that they have selected, and the may read reviews of financial service providers that have been posted by other property owners.

Subsequent to completing their evaluation of DCE technologies 209, brands of DCE equipment and DCE products 210 DCE system installers 211, and financial products and financial service providers 212, in the manner provided above, property owners are provided with resources to enable them to request information and proposals from the product manufacturers, installation service providers, and financial product/service providers they have selected. Those property owners who have completed the multi-step assessment protocol themselves 201, and those property owners who complete the multi-step assessment protocol with curated guidance provided telephonically or via live computer “chat” 202, identify the manufacturers and service providers they have selected from a database provided by the host of the system 218 219 220. Property owners that have subscribed to the concierge consulting service provided by the host of the system 203 will, after consultation, specify the number of product manufacturer, installation service provider, and financial product and service provider contacts that they would like to receive. The host of the system will then recommend specific product manufacturers, installation service providers (we sometimes use the phrase installation service providers interchangeably with the word installers), and financial service providers 218 219 220 in the numbers that the subscribers to the concierge consulting service have specified.

Millions of consumers have registered with the National Do Not Call Registry hosted by the Federal Trade Commission (FTC) and Do Not Call Registries hosted by the states in which they reside. Once a consumer has signed up for the National Do Not Call Registry and/or a state Do Not Call Registry, marketers must receive the registered consumer's express written authorization prior to telephoning them. This consent expires at the conclusion of ninety days, if by the 90th day the consumer has not purchased something from the marketer, received a delivery from the marketer, or made a payment to the marketer, in which case the consent expires eighteen months after the consumer's last purchase, delivery, or payment.

When property owners have completed the multi-step assessment protocol themselves 201, or have completed the multi-step assessment protocol with curated guidance provided telephonically or via live computer “chat” 202, they then identify the product manufacturers and service providers (e.g., installers) from whom they would like to receive additional information and/or proposals 218, 219 and 220. When property owners who have completed the multi-step assessment protocol themselves 201, or who have completed the multi-step assessment protocol with curated guidance provided telephonically or via live computer “chat” 202 to identify the product manufacturers and service providers from whom they would like to receive additional information and/or proposals, they are presented with an online form that explicitly states that by electing to receive such information and/or proposals they are consenting to be contacted by the manufacturers and providers they have selected. When property owners who have subscribed to the concierge consulting service provided by the host of the system receive recommendations regarding product manufacturers and service providers from the host of the system, they are also provided with a form that explicitly states that by electing to receive such information and/or proposals they are consenting to be contacted by the manufacturers and providers they have selected.

Once a product manufacturer 218, installer 219 or financial product/service provider 220 has received a request they are responsible for their interactions with the property owner, the information that they provide, the proposals that they prepare and deliver, and the products and services that they deliver. It is likely, then, that product manufacturers 221, installers 222, financial product/service providers 223 will exchange further information with the property owners prior to and subsequent to property owners' decision to purchase, finance, and install a DCE system.

In some implementations, the host of the system may also provide customer relationship management support to product manufacturers 221, installers 222, and financial product/service providers 223 while they exchange information with property owners. Specifically, the host of the system will help product manufacturers 221, installers 222, and financial product/service providers 223 (i) to monitor and schedule their continuing contact with those property owners from whom they have received a submitted request, (ii) help them to develop substantive responses to information requests based on the weighted recommendations property owners received from the host of the system, and (iii) help them to generate informative, actionable proposals based on suggestions made by property owners who have already purchased DCE systems.

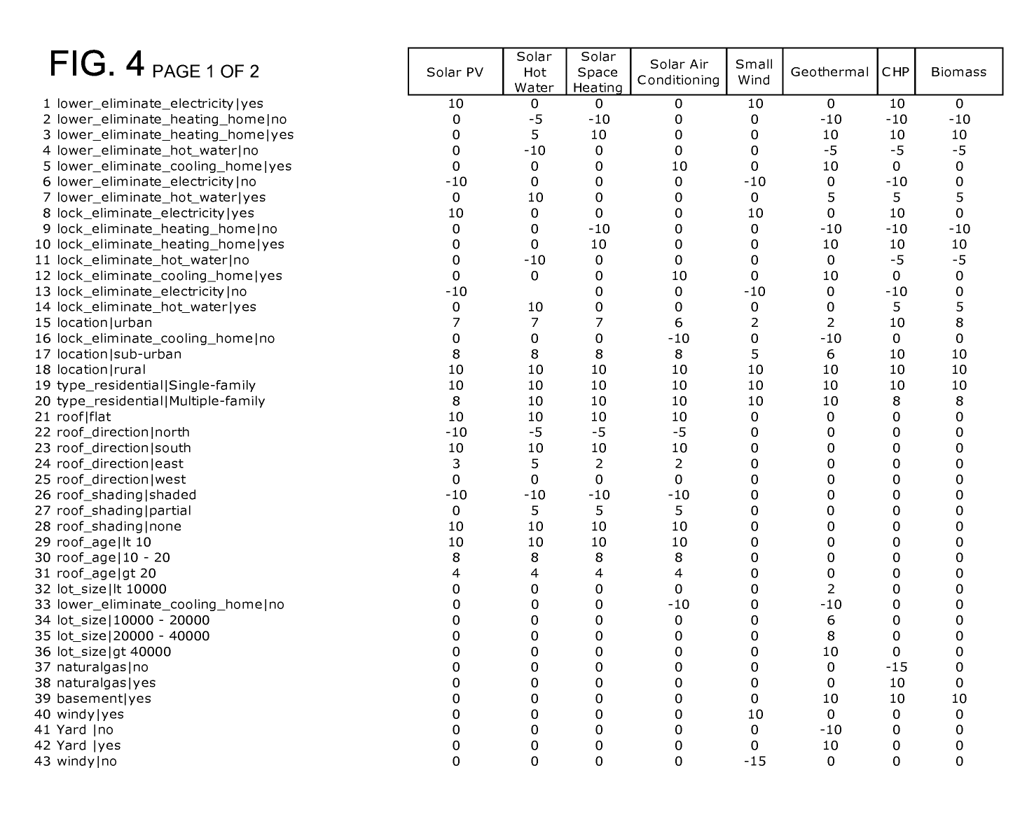

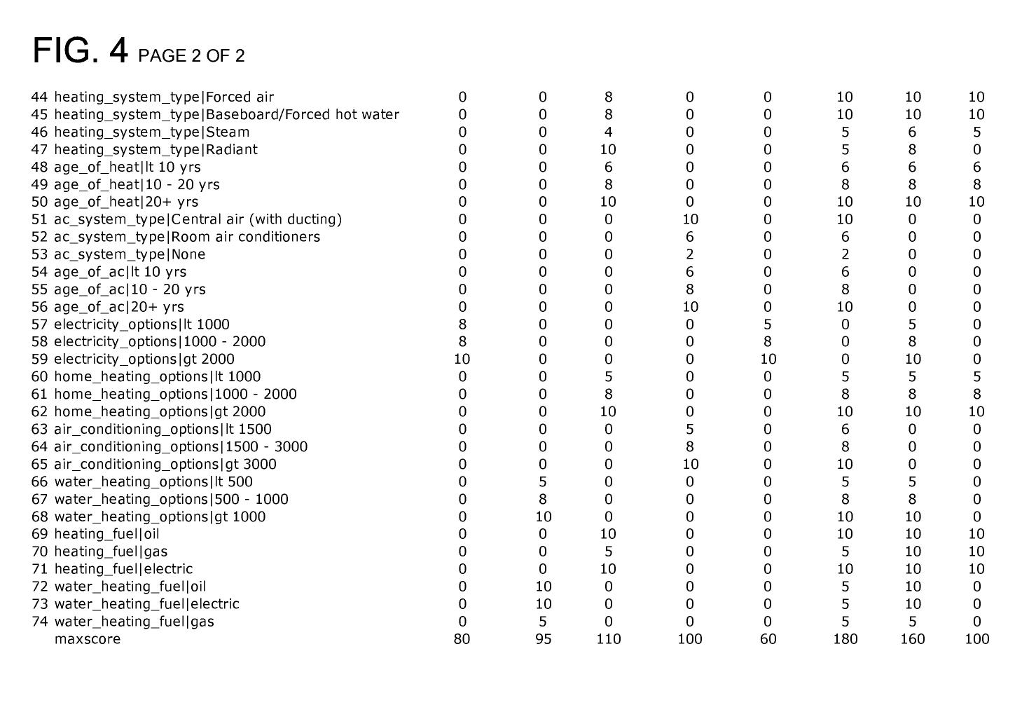

Referring now to FIG. 3, there is shown the processes of a proprietary algorithm included in the assessment protocol. As described above, the data that is employed by the algorithm in some implementations is based on inputs provided by the user—responses to customized questions—that are then assigned numerical values by the host of the system. The customized questions represent a protocol: they acquire required inputs from the user which are then paired with additional data provided by the host of the system (see FIG. 4), and then weighted using a proprietary algorithm to score each DCE technology with respect to, in one embodiment, its suitability, its acquisition cost, the annual savings that it is anticipated to yield, the ROI that it is anticipated to produce, as well as its comparative environmental benefit measured in terms of offset carbon emissions.

The customized questions are arranged and presented in separate categories that may include, but are not limited to, questions regarding the property owners' goals, the attributes of their properties, their current energy systems, and demographic information. In FIG. 3 these are labeled CATEGORY I, CATEGORY II, and CATEGORY n, to indicate that any number of such categories may be included as part of the assessment protocol and employed by the algorithm.

The processes of the algorithm are initiated when the user responds to the first customized question in CATEGORY I 301. Based on the user's response to the question a separate value is assigned to each DCE technology type 302. For example, if a user is asked if their goal is to lower or eliminate their electricity bill, a value of “10” would be assigned to the solar photovoltaic DCE technology type, but a value of “0” would be assigned to the geothermal DCE technology type. (FIG. 4 illustrates one embodiment of the numerical values assigned in this fashion.) FIG. 3 illustrates the process of assigning values for “DCE Technology 1,” “DCE Technology 2,” and “DCE Technology n” to indicate, again, that any number of DCE technology types may be included as part of the assessment protocol and calculated by the algorithm. The numerical values assigned to the DCE technology types based on the user's response to the first customized question are stored by the host, and may be retrieved later if the user wishes to postpone completion of the assessment protocol and resume it at a later time 303.

The process is continued when the user responds to the second customized question. 304 Once again, based on the response to the second customized question, a separate value is assigned to each DCE technology type 305. These numerical values are also stored by the host 306.

This process is continued, seriatim, for each of the questions until the final customized question has been answered 307. As before, the final set of separate numerical values are assigned to each DCE technology type based on the response to the question 308. The final set of numerical values is then stored by the host 309.

After the final set of numerical values has been stored in the server, a mathematical function is performed to derive a weighted average of such values for each DCE technology type 310. The function sums the values assigned in each category (e.g. property owners' goals, the attributes of their properties, their current energy systems, and demographic information), and divides the sum of that set of values by the number of values in the set (ΣA1, A2 . . . AN)÷N; for example, 2+5+5÷3=4). 310 The same mathematical function is then performed to derive a weighted average of the numerical values assigned to each DCE technology, in each category, based on the user's responses to each question included in the assessment protocol.

After the mathematical function is used to perform the final calculation the results (the weighted averages of relevant parameters (categories) for each DCE technology) are published in numerical or graphical format either in hard copy, or in HTML or another Internet document format (a “recommendation”) 311. The recommendation ranks the relative suitability of the plurality of DCE system types taking into account, among other possible criteria, their relative acquisition costs, the relative annual savings that the installed DCE systems are anticipated to yield; the ROI that the installed DCE systems are anticipated to produce, as well as the comparative environmental benefits of the DCE systems measured in terms of the carbon emissions they offset 312

Referring now to FIG. 4, there is shown a spreadsheet that illustrates example numerical values set by host of the system and assigned as part of the assessment protocol (see FIG. 1, 103) to users' responses to questions regarding the attributes of their homes and businesses, their energy consumption (electricity, natural gas, heating oil, etc.), and their individual consumer preferences, etc. These example numerical values themselves are inputs made by the host of the system based on inputs made by users when they respond to questions regarding the attributes of their homes and businesses, their energy consumption (electricity, natural gas, heating oil, etc.), and their individual consumer preferences, etc. It is these numerical values which, in turn, are used by the algorithm in FIG. 3 to derive the weighted averages of relevant parameters (categories) for each DCE technology in order to rank the relative suitability of the plurality of DCE system types taking into account, among other possible criteria, their relative acquisition costs, the relative annual savings that the installed DCE systems are anticipated to yield; the ROI that the installed DCE systems are anticipated to produce, as well as the comparative environmental benefits of the DCE. The embodiment depicted in FIG. 4 lists 74 possible user responses, and the values assigned to each of the DCE technology types. The number of possible variations in the number of responses, the number of DCE technology types, and the assigned numerical values that are assigned is numerous, and each would represent a different embodiment of this system of assigned values.

The advantages of some implementations include, without limitation: that they enable consumers to evaluate a full range of DCE technologies simultaneously, not serially; that they provide consumers with the ability to evaluate each type of system on a comparative basis, taking into account the attributes of their homes or businesses; the relative cost of each type of system; the annual savings that each type of system is likely to produce; the ROI that each type of system is likely to produce; and the comparative environmental benefit associated with each type of system; that they provide consumers with resources to facilitate their selection of DCE manufacturers, brands and products, and related installation and financial service providers; that they communicate consumer requests for information and project proposals directly to manufacturers, and professional and financial service providers including installers; and that they provide resources to those manufacturers, and professional and financial service providers to manage the relationships they establish with consumers via some implementations.

Some implementations may include a system enabling consumers to evaluate distributed clean energy (DCE) technologies across a range of relevant parameters, facilitating consumer selection of products and related installation and financial services, transmitting consumer requests for products and services to qualified vendors, and providing product manufacturers and installation and financial service providers with a means to manage their relationships with the consumers whose requests they have received via some implementations.

The platform may, for example, simplify the solar PV system purchase process for POs and help them get the best price by automating the collection and comparison of multiple quotes.

The platform may help energy system installers increase the volume of their business and increase their profit margins by reducing their sales costs (e.g., by 60%) and providing access to a large pool of knowledgeable, ready-to-buy consumers.

In some implementations, the platform may include both the system analysis and selection features described above and the acquisition assisting features described below. In some implementations, two different platforms providing the two different sets of features can be offered. In some implementations any mix of the features can be offered in any number of different platforms.

In some implementations, the following example process is used to facilitate a PO's purchase of an energy system or associated services (e.g., installation) from an installer that may be one of several installers offering comparable energy systems or services.

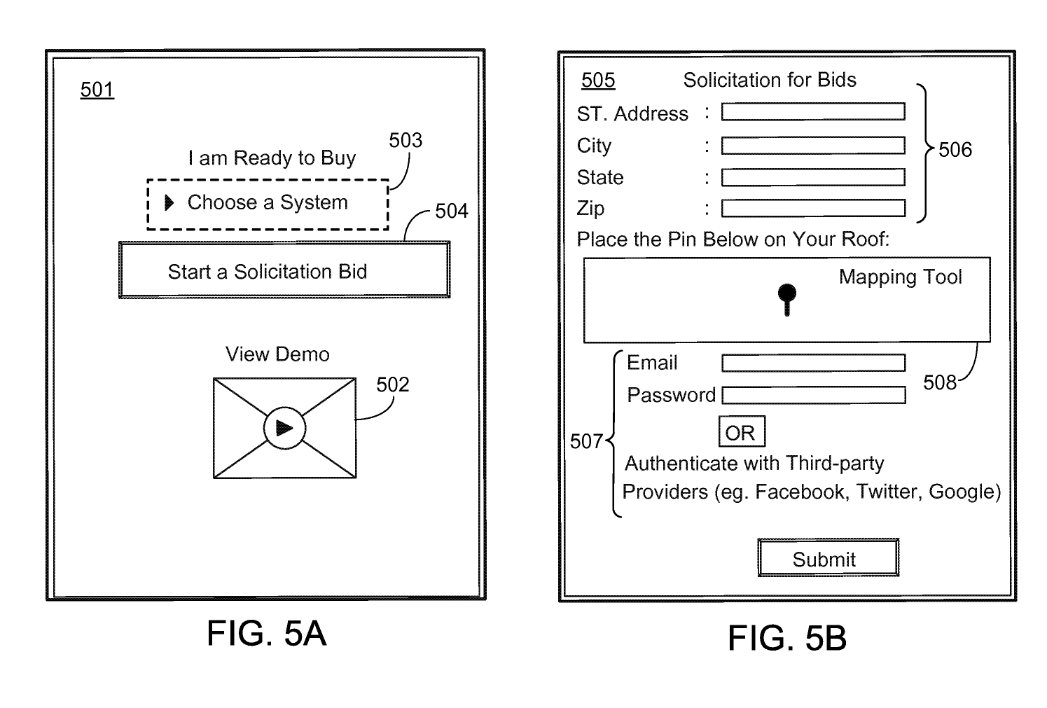

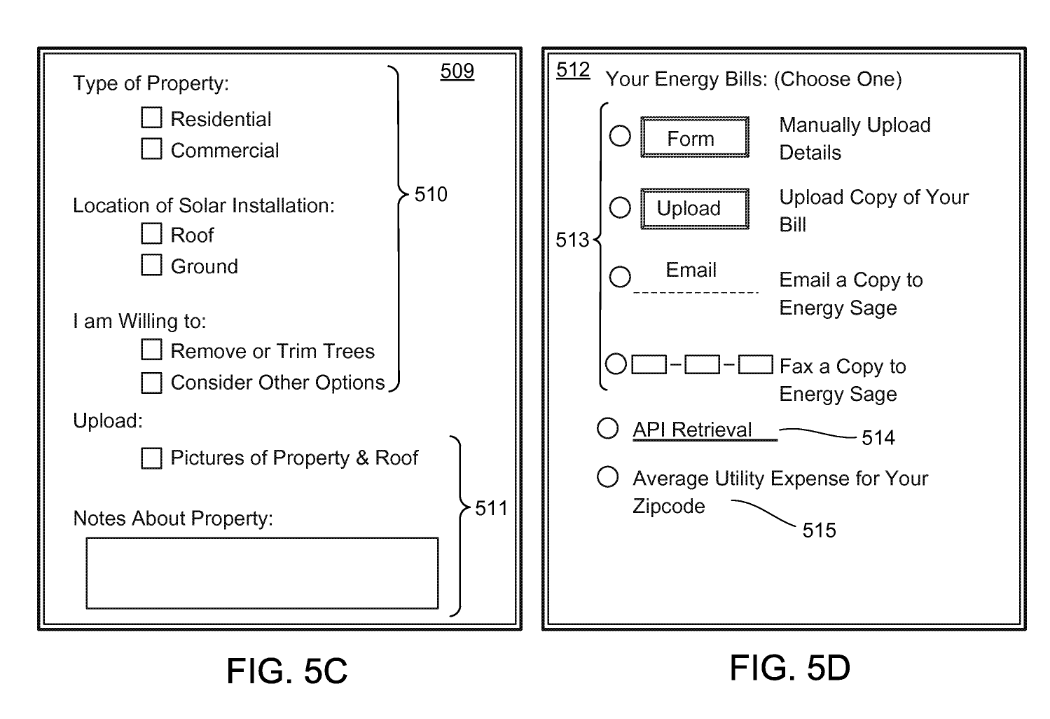

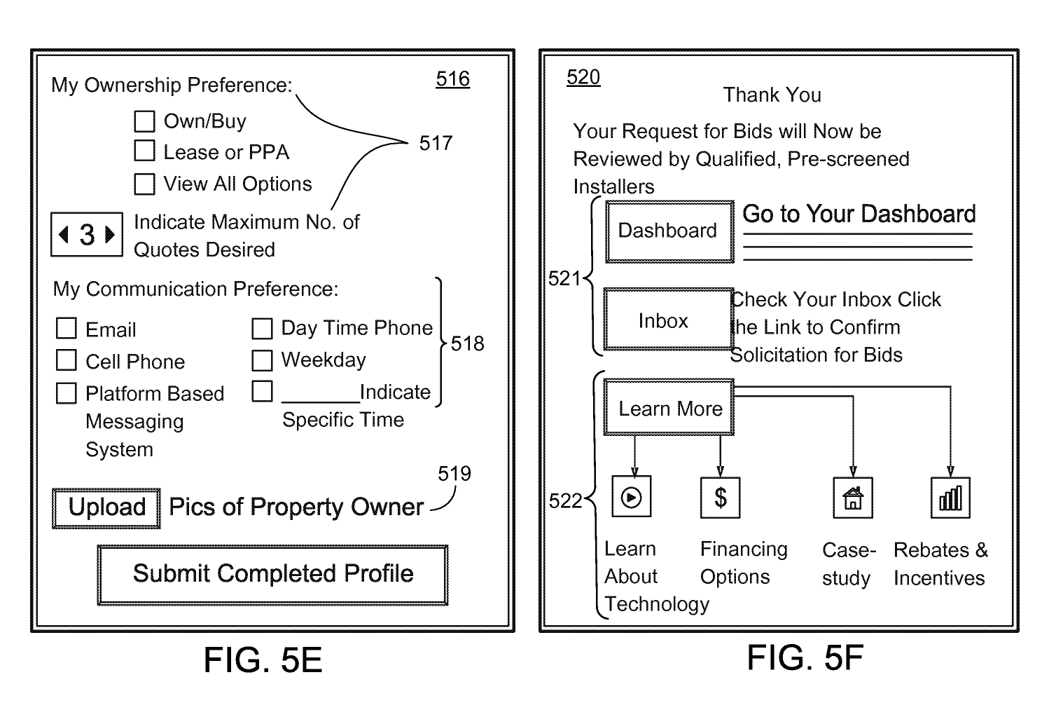

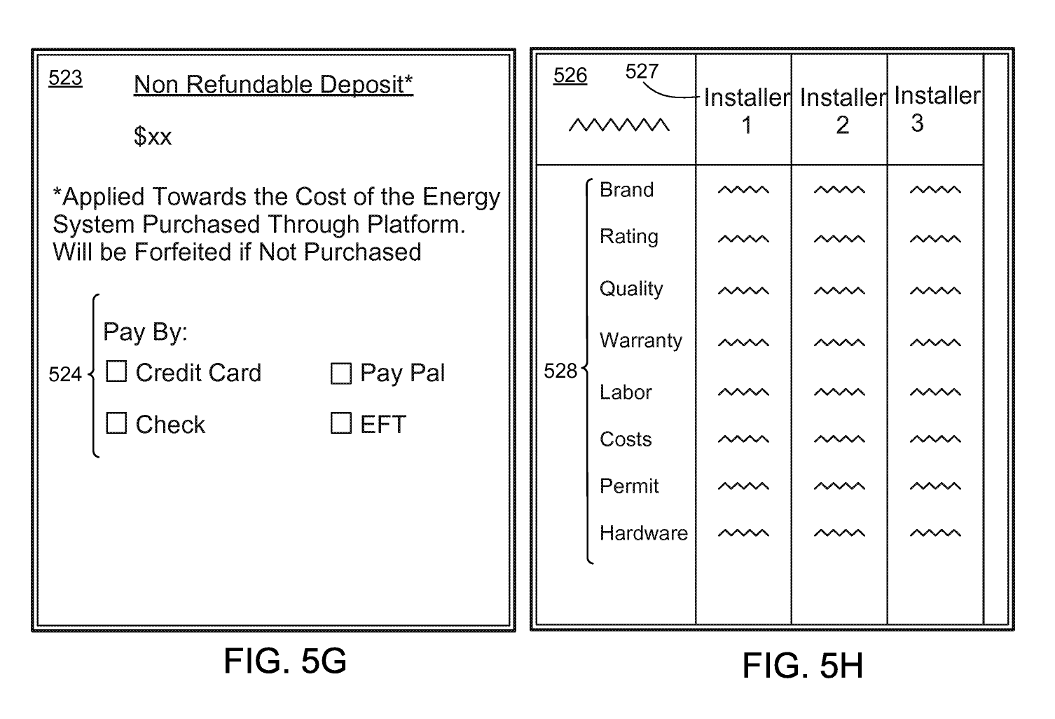

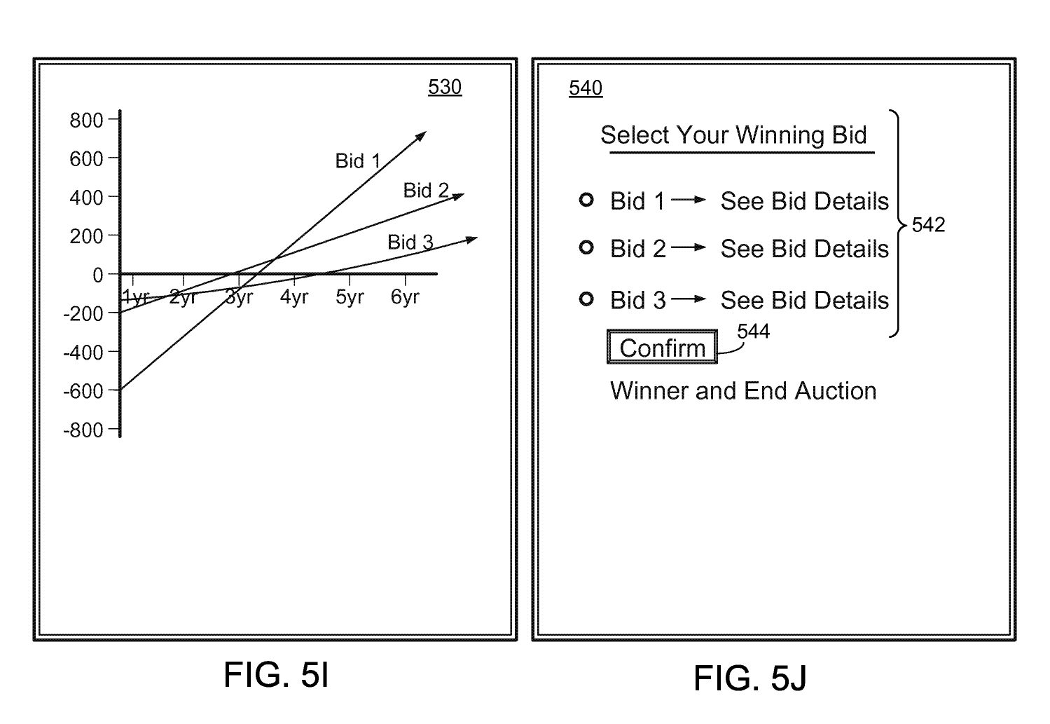

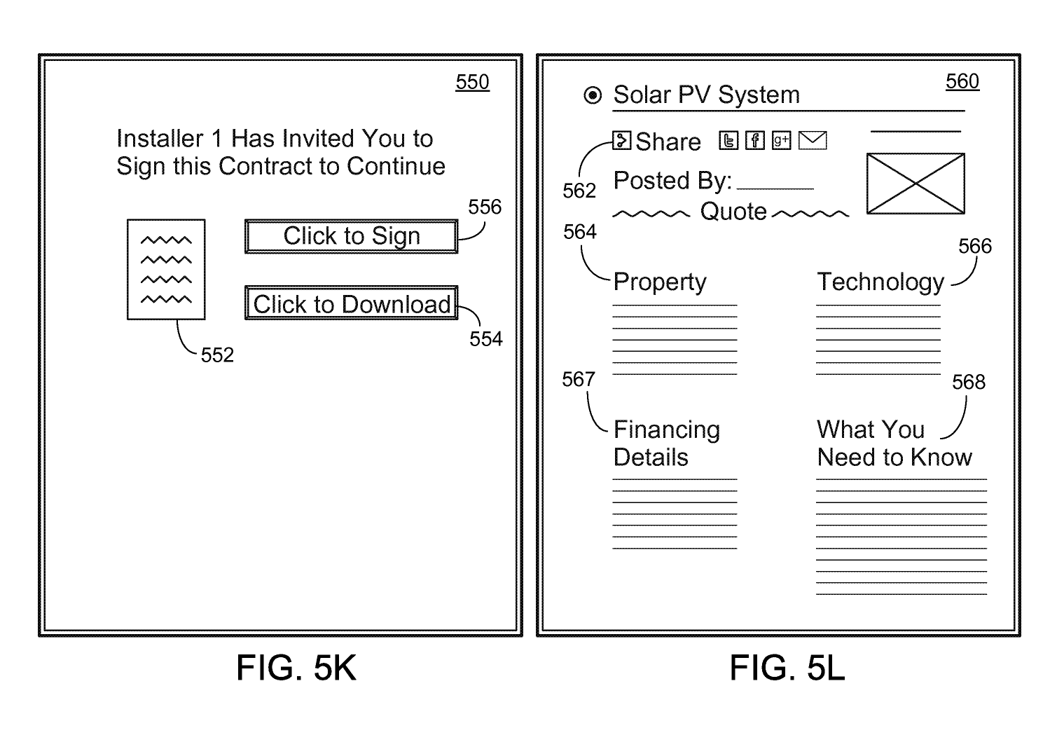

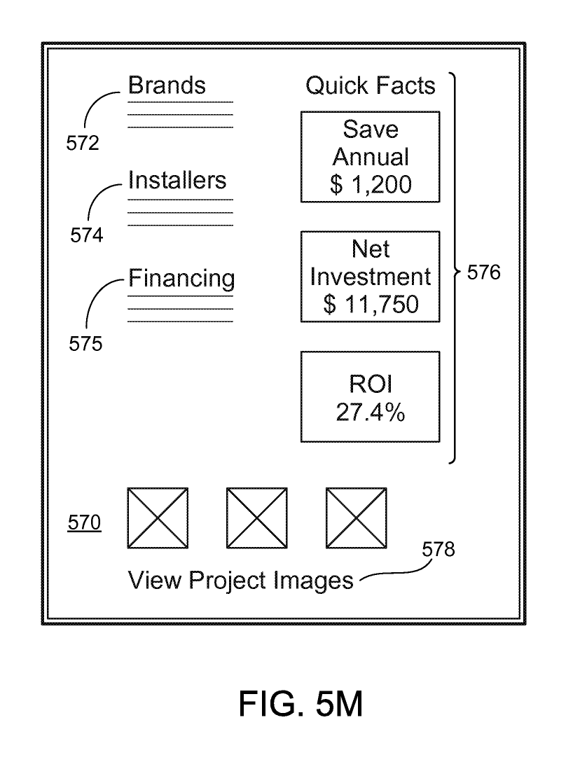

Referring to FIG. 5A, a PO may access the platform using an online graphical user interface (GUI) including a welcome screen 501. A PO may choose to see a demonstration (e.g., a video illustrating use of the platform) of the process before beginning The platform may include a demonstration or a link 502 to a demonstration. The PO may determine which type or model of energy system they intend to buy. The PO may use an energy system wizard to determine which energy system or set of energy systems is a technically feasible solution, a suitable solution, or a technically feasible and suitable solution for their property. Features of such a wizard can include some of the features described earlier and other features. For example, the welcome screen 501 includes a link 503 to an energy system wizard. For example, the PO may decide to purchase a solar PV system. The PO may also initiate a solicitation of quotes for the solar PV system by clicking the start solicitation link 504.

The PO may register with the platform. A PO can register with the platform before they initiate a solicitation for quotes or concurrently with submission of their solicitation for quotes. Referring to FIG. 5B, a registration screen 505 may prompt the PO for address information with a form 506. In some implementations, the PO may be presented with the option to authenticate 507 their registration and email address and password or using a distributed authentication provider (e.g., Facebook, Google, OpenID, etc.). In some implementations, solicitation profile information will only be made public to the installer when an email is confirmed and validated. The PO may continue uploading additional property profile data while waiting for validation, which may be announced via email.

In some implementations, the PO will be shown an online map 508 (e.g., Google Earth, Bing Bird's Eye) and asked to confirm the location of the property on the map. For example, the location may be confirmed by placing a virtual pin on the map at the location of the property. In some implementations, the PO may be enabled to draw a boundary around the property on the map.

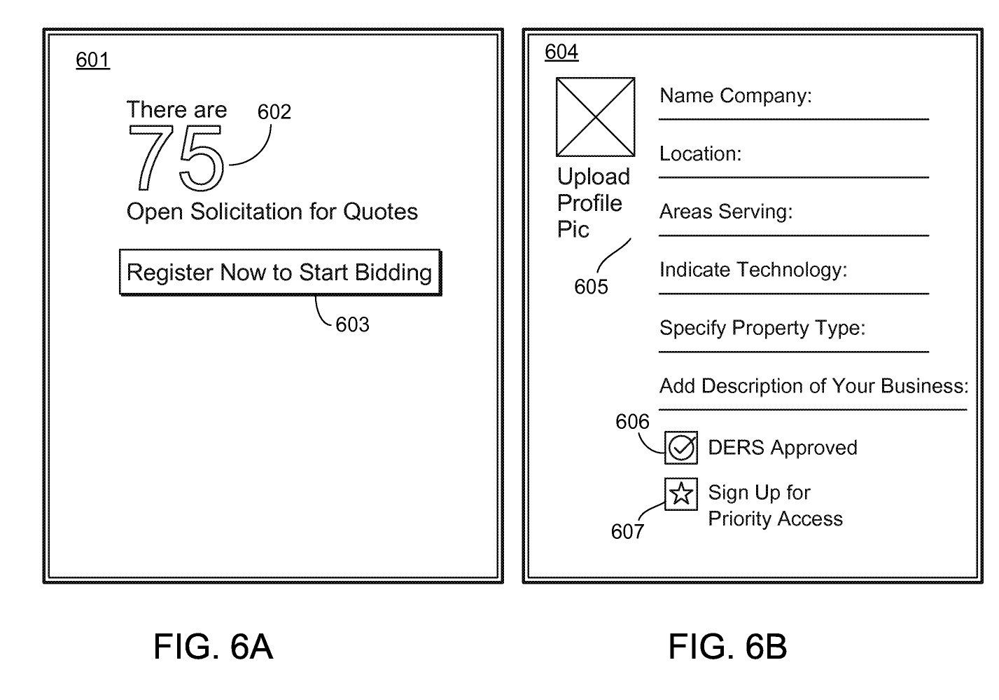

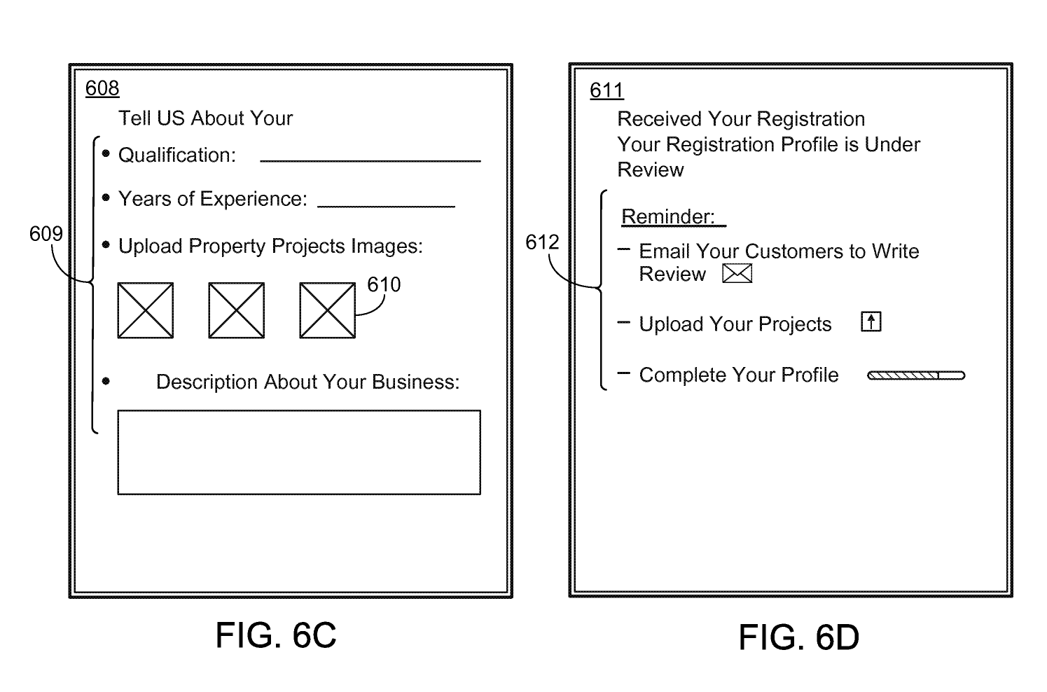

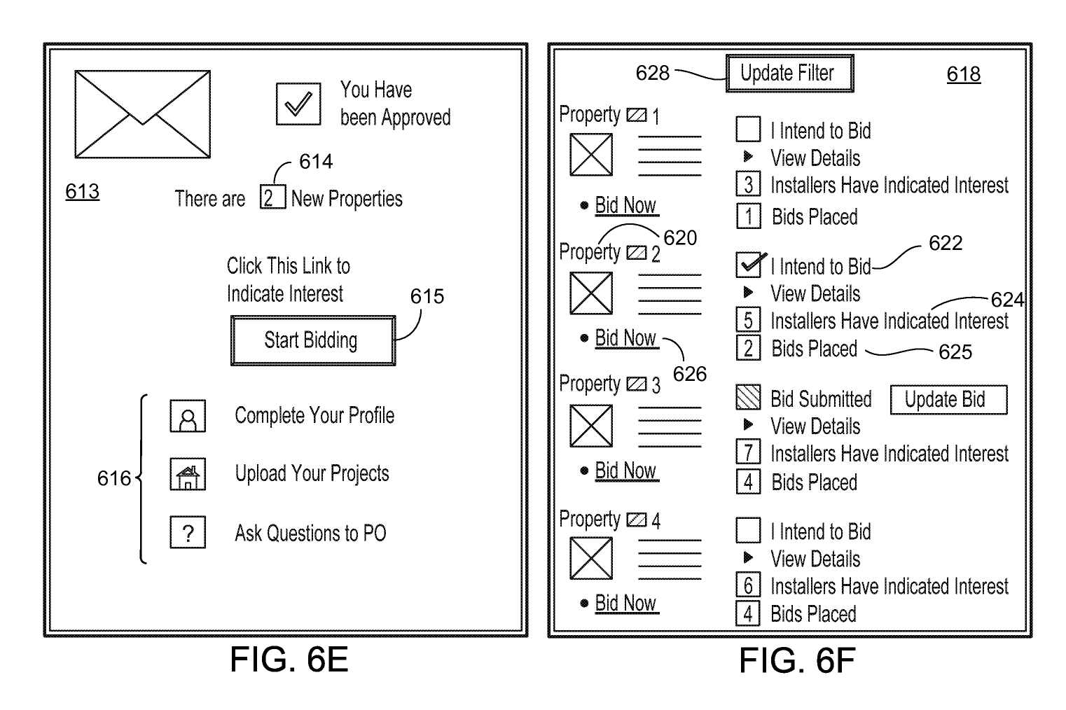

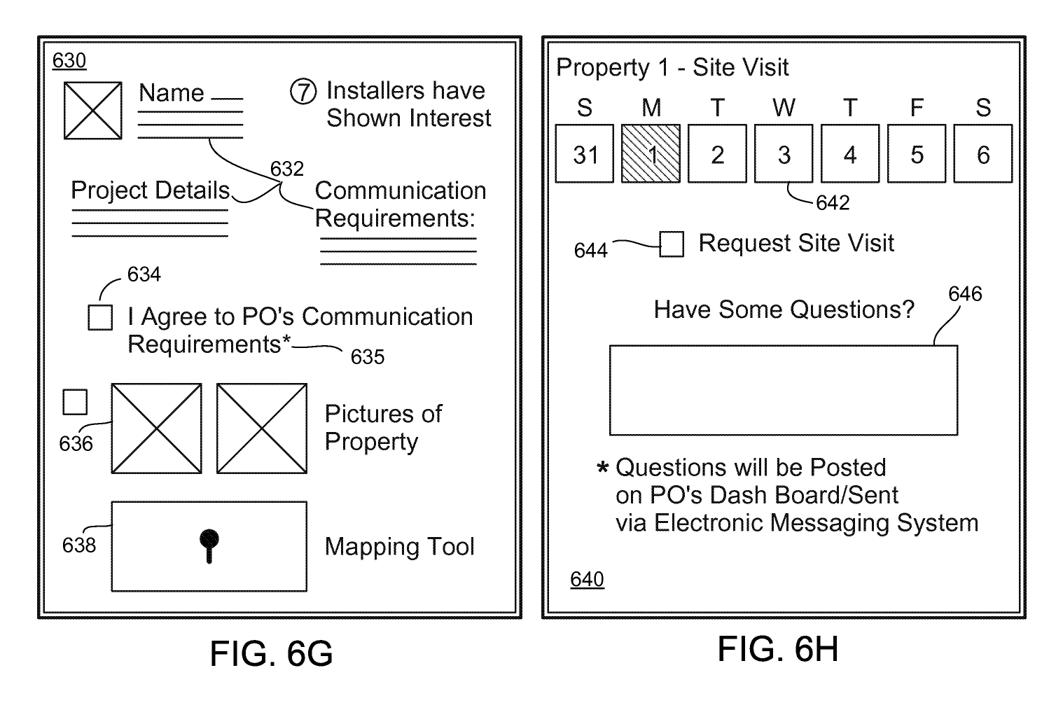

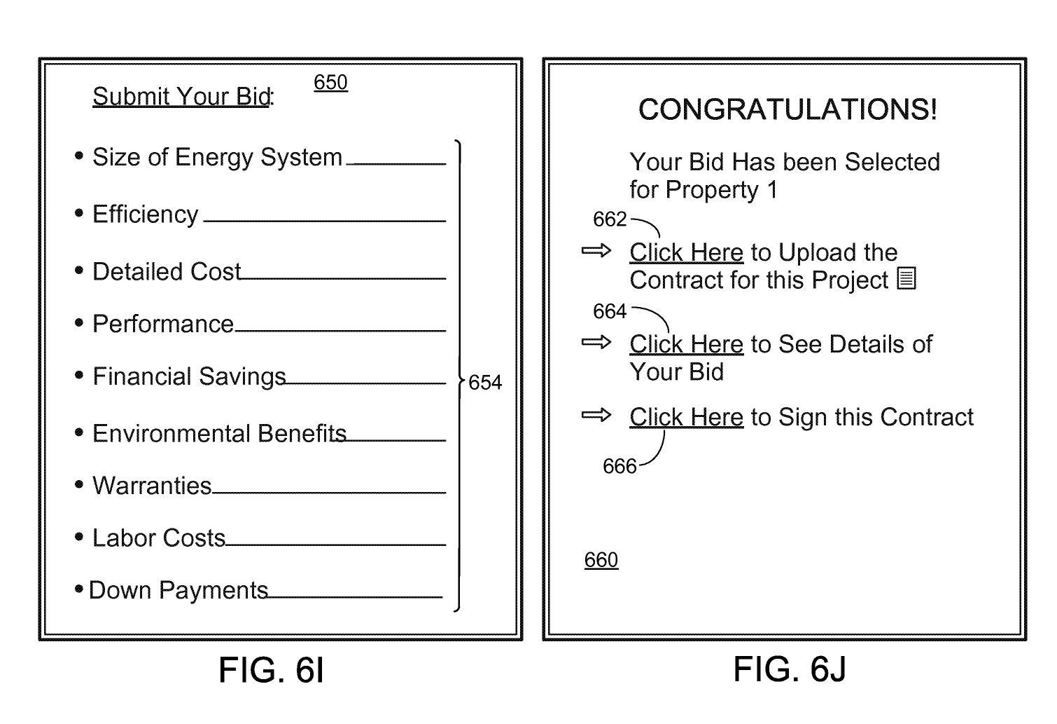

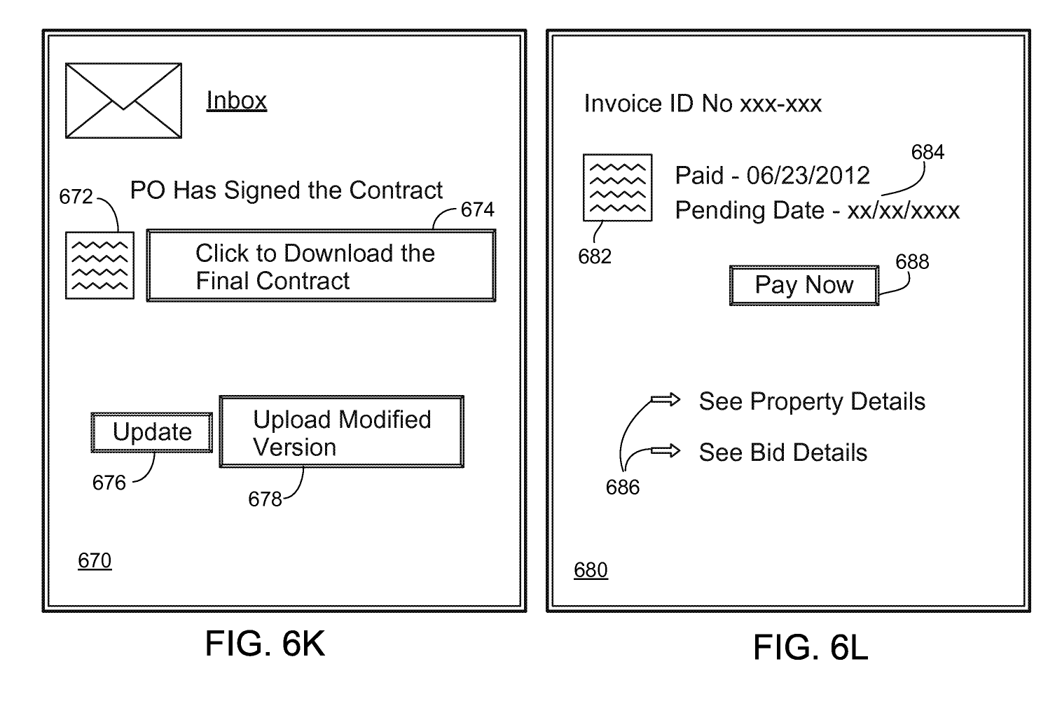

An installer (possibly among many similar installers) registers with the platform. FIG. 6A depicts a welcome screen 601 portion of an example GUI used by an installer to access the platform. The welcome screen includes a count 602 of the number of open solicitations for quotes currently available on the platform, which may induce a new installer to click on the registration link 603 to initiate registration and bidding. The installer creates a profile on the platform. For example, referring to FIG. 6B, the profile screen 604 of an example GUI for installers includes a form 605 with numerous fields that may be used to enter profile information. The installer profile includes information such as: contact information, website address (URL), business description, pictures, names of officers and key contacts, and preference parameters specifying types of solicitations for quotes the installer wishes to consider. These preference parameters may include energy system type, size of project (e.g., in terms of price, hours required to complete, system size), location/geographic area, type of property, etc. The installer profile information may appear on an administrator dashboard for approval by an administrator of the platform. In some implementations, the platform administrator prescreens installers taking into account their experience, customer testimonials, certifications and licensing, etc. The administrator may approve the installer to participate in the solicitation for quotes process. For example, referring to FIG. 6C, the qualification screen 608 of an example GUI for installers includes fields 609 allowing the installer to submit information describing the installer's business, qualifications, and years of experience as well as images 610 from the installer's portfolio of past projects, and/or links to web pages hosted on the platform that profile energy systems installed by the installer. The profile screen 604 of the example GUI also includes platform approval status indicator 606 and also a link 607 for requesting priority access to solicitations on the platform.

When the installer finishes the registration submission, the installer may be presented with a thank you screen 611 as shown in FIG. 6D. The thank you screen may include context-sensitive links 612 that serve to prompt the installer to complete outstanding tasks (e.g., ask prior customers to write reviews, upload additional previous project information, or complete a portion of the installer profile). If and when a platform administrator approves the installer's registration, the installer may receive email 613 notification, as shown in FIG. 6E, and/or notification through some alternative communications channel from the platform. A notification message may include a count 614 of new properties accepting quotes, an invitation with a link 615 to start bidding (i.e., submitting quotes), and context-sensitive links 616 that serve to prompt the installer to complete outstanding tasks (e.g., complete installer profile, upload project data, or ask questions of POs).

The PO may initiate a solicitation for quotes on the platform. The platform receives information from the PO to create a solicitation profile on the platform. A solicitation profile is a data structure that may be stored in a database or other data storage device. A unique identifier may be generated and used to identify this solicitation profile uniquely within the platform and throughout future interactions. In some implementations, the platform may use data from proprietary or third-party databases to pre-fill some of the information in the solicitation profile.

The information requested from the PO during the creation or editing of the solicitation profile may be customized based on the energy system selected by the PO. The information requested may include but is not limited to: the address of the property; names and contact information of the PO or representatives of the PO; a description of their property (e.g., residential or commercial, square footage, number of floors, etc.); pictures of the property; energy consumption history and/or utility bill(s); indication of the PO's willingness to modify the property to install an energy system (e.g., trimming or removing trees in the case of solar PV); preference for ownership or third-party financing structures (e.g., secured or unsecured loans, lease agreements, power purchase agreements (PPAs)); and quote acceptance requirements.

For example, referring to FIG. 5C, a property details screen 509 of the example GUI for POs includes check boxes 510 that allow the PO to specify the type of property (residential or commercial), the location of a solar PV installation within a property (ground or roof), and the PO's willingness to modify the property (e.g., trim trees). The property detail screen 509 also includes fields 511 that allow the PO to submit pictures and a description of the property.

Quote acceptance requirements may include, but are not limited to: a maximum price; a maximum number of quotes the PO is willing to receive; being presented only the top quotes meeting their specified criteria (e.g., lowest installed cost in $/Watt); a maximum number of installers who will be permitted to conduct site visits at the property; a date or range of dates when they would like the energy system to be installed; the length of time the solicitation period will remain open (i.e., during which quotes will be considered); types of installers based on certain criteria (e.g., size, location, experience, brands offered, type of financing provided, etc.); an indication of one or more preferred communication channels (e.g., email, telephone, or a platform-based messaging system) that constitutes express written permission authorizing installers to contact the PO via those channels (e.g., even if the PO's telephone number/email is listed on the National Do Not Call Registry); and an indication that all or some communications from installers should be routed via the platform's communication tools and not via alternative communication channels (e.g., email or telephone).

FIG. 5E shows a PO preferences screen 516 of the example GUI for POs, which includes an ownership preference prompt 517 that allows the PO to specify the number of quotes desired for consideration and whether the PO prefers to own the energy system, lease it, execute a PPA, or pursue some alternative financing model to acquire the energy system. The PO preferences screen 516 also includes a communications preferences prompt 518 that allows the PO to specify preferred communication channels (e.g., email, telephone, or a platform-based messaging system) and timing restrictions for certain communication channels. The PO preferences screen 516 also includes a PO picture upload prompt 519 that allows the PO to upload a picture to the platform that may be presented to other users of the platform including installers who may arrange site visits and other meetings with the PO.

A PO may be presented with multiple options to provide data reflecting energy consumption history or utility bills to the platform. The PO may manually enter the details via a standard form, upload an electronic copy of their utility bills, email an electronic copy of their utility bills, or fax a copy of their utility bills. For fax and other out-of-band channels, the unique solicitation identifier may be included in the utility bill submission. In some implementations, an estimate of the utility bills may be generated based on utility expense averaging for properties within the same postal code as the property. In some implementations, utility or energy bill data may be gathered directly by the platform from a third party system (e.g., the utility company's web site or a data aggregator or intermediary) via machine-to-machine application programming interface (API) or “screen scrape” method on the behalf of the PO, who may be prompted to provide the necessary authentication credentials to access their data from the third party system.

FIG. 5D shows an energy bills screen 512 of the example GUI for POs, which includes prompts 513 that facilitate submission of the PO's energy bills in various formats an through various communication channels. Billing information submitted may include, e.g., a utility name, a utility account number, total consumption in a month in kWh, therms, or other standard units, total charges in a month, total annual consumption in kWh, therms, or other standard units, and similar data for a sequence of months or years. The energy bills screen 512 also includes an API retrieval link 514 for launching a machine-to-machine API retrieval application to facilitate the collection, formatting, and submission of billing information. Energy bills screen 512 also includes an average utility expense for your zip code link 515 for launching a tool to use third party data for the postal code of or other area proximate to the property to estimate consumption patterns on the PO's property.

In some implementations, the platform may require a non-refundable deposit from the PO. This deposit will be applied towards the cost of the energy system purchased through the platform and may be forfeited if the PO does not purchase an energy system via the platform. A non-refundable deposit, for example, may incentivize transaction completion which may in turn incentivize quote submission by installers. FIG. 5G shows a non-refundable deposit screen 523 of the example GUI for POs, which includes an explanation of the policy and payment option links 524 that facilitate submission of the non-refundable deposit.

The PO submits the completed solicitation for quotes. The completed solicitation for quotes will be stored and formatted into a solicitation for quotes page that POs can return to for purposes of reviewing and revising the information they posted, and to communicate with installers. A solicitation for quotes page may be accessible via a standard web browser client or mobile application. In some implementations, a solicitation for quotes page may be accessible through a personalized online interface, referred to as a PO dashboard. After submission, the PO may be presented via email or some other communications channel with context-sensitive information, for example links to the technology descriptions, case studies, installer profiles, and a description of the next steps of the process. FIG. 5F shows solicitation submission confirmation screen 520 of the example GUI for POs, which confirms receipt of the solicitation profile and includes navigation links 521 that allow the PO to access their PO dashboard and their inbox in the platform-based messaging service. The solicitation submission confirmation screen 520 also includes links 522 to a suite of educational resources (e.g., images, videos, financing option information, energy system case studies, and information regarding available rebates and other energy systems incentives).

The PO may be sent an electronic confirmation that their solicitation for quotes has been successfully submitted. The platform may electronically transmit educational material including links back to proprietary or third-party websites with additional educational material. The PO may be asked about their level of knowledge regarding the energy system for which they have published a solicitation for quotes, and may be provided customized informational and educational material that is suited to their level of knowledge regarding the energy system profiled in their solicitation for quotes. The PO may be presented with the option to request additional information and post questions directly to installers, the platform's consumer community (e.g., other POs), or a platform administrator. Educational material sent to the PO may include, but not be limited to, descriptions of energy systems, their applications, suitability criteria, costs and drivers of cost, benefits (e.g., financial, environmental, reliability), guidance on determining optimal size for the energy system, guidance on selecting brands, installers, case studies, profiles of similar energy systems installed in similar properties located in comparable climates and geographies, and photographs or videos of similar or identical energy systems.

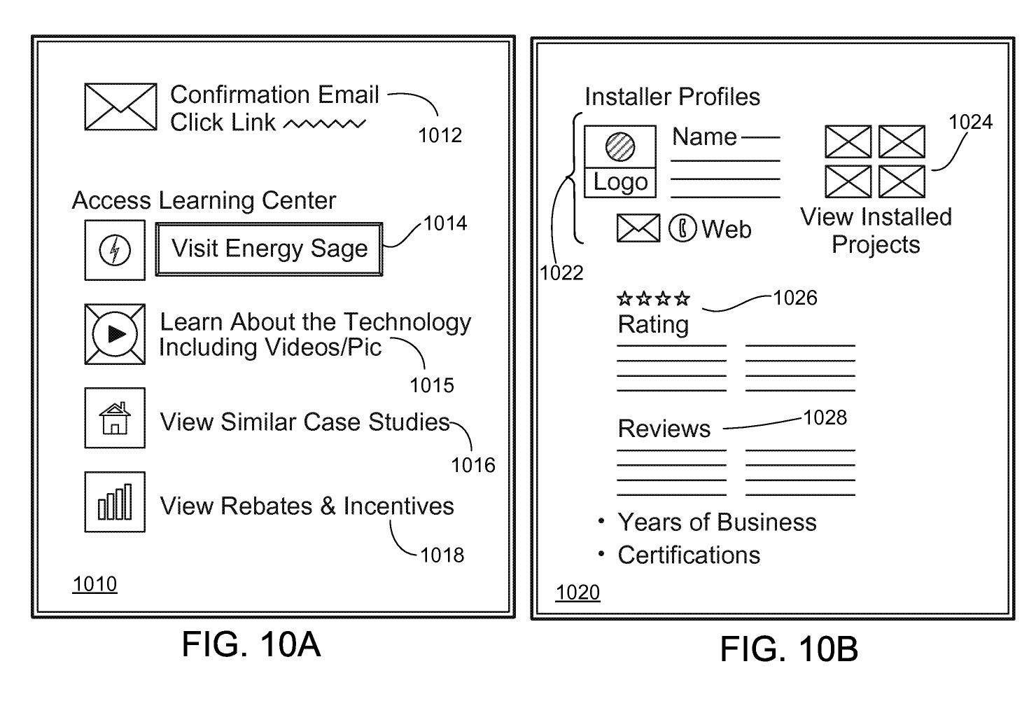

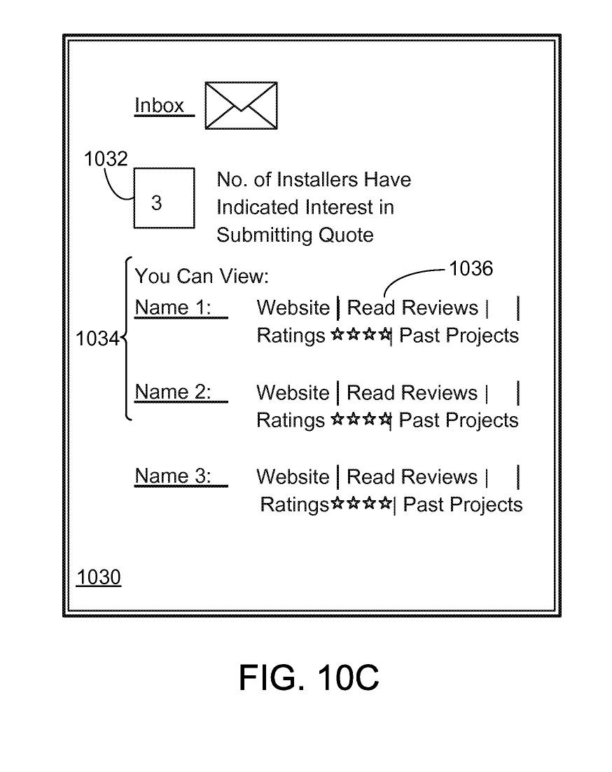

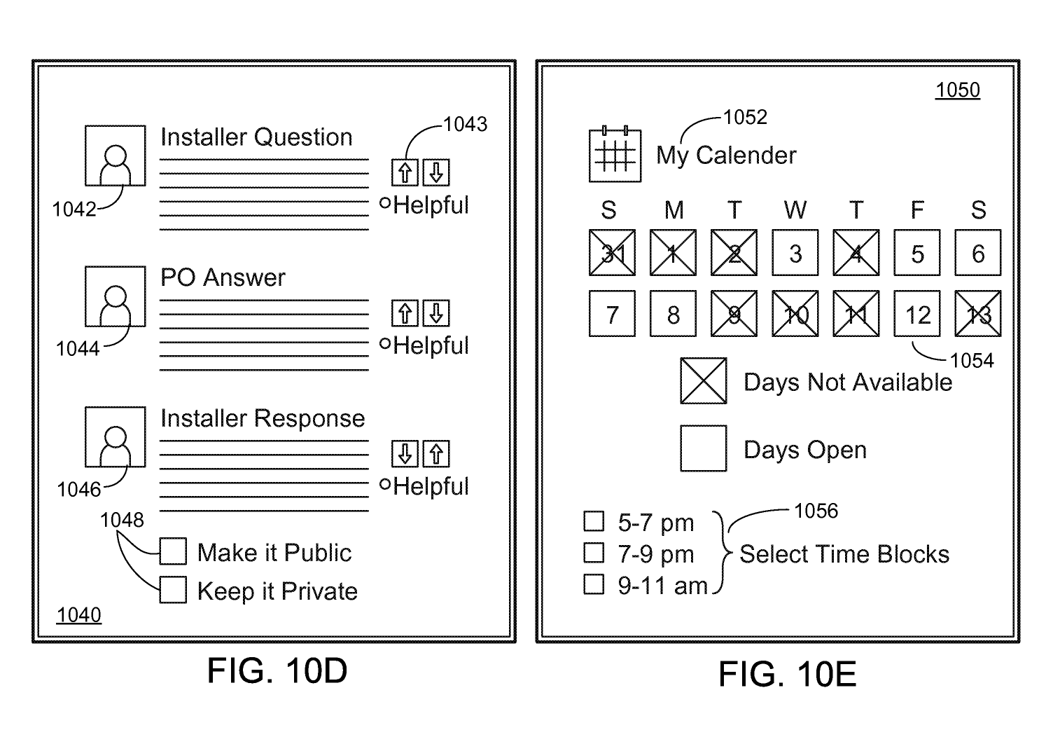

FIG. 10A shows an example solicitation submission confirmation email 1010 that may be sent to a PO, which confirms receipt of the solicitation profile and includes a link 1012 that allows the PO to verify their email address after registering and submitting a solicitation profile. The solicitation submission confirmation email 1010 also includes a link 1014 to a suite of educational resources available on the platform. The solicitation submission confirmation email 1010 also includes context-sensitive deep links to particular educational materials 1015 (e.g., images and videos), similar case studies 1016, and information regarding relevant rebates and other energy system incentives 1018 that are tailored to the submitted solicitation profile.

The PO may be provided with a dashboard to manage the purchase process. For example, the dashboard may display: the status of the PO's solicitation(s); indications of progress through the solicitation for quotes process, including context-sensitive content about what to expect in future steps; and a record of communications with installers. The PO's dashboard may be the primary interface for an authenticated PO accessing the platform.

In some implementations, the PO dashboard displays and provides the ability to edit a description of the PO's active solicitations for quotes, including, e.g., address and contact information, property profile information, communications with installers regarding the solicitation, and a calendar for scheduling site visits with installers. In some implementations, the PO dashboard shows or links to: a comparison and evaluation tool; guidance and advice tools to analyze the quotes, including tools to determine whether owning the solicited system, leasing the solicited system, executing a PPA, or some other financing or ownership model offers the greatest financial returns; educational materials; a progress indicator for the solicitation for quotes; an energy system wizard that may be used to determine the suitability of energy systems for the owner's property or the owner's consumer preferences; and profiles, ratings and reviews of installers, brands, and financing companies. The comparison and evaluation tool may include one or more tables showing details for submitted quotes from all installers and for all pricing and financing options. The progress indicator may include an enumeration of solicitation for quotes process steps and indication of where they are in the process, including context-sensitive material according to current step such as the expected time duration of the current step, what is required of the PO during that step, and what the PO can expect during that step and the following step.

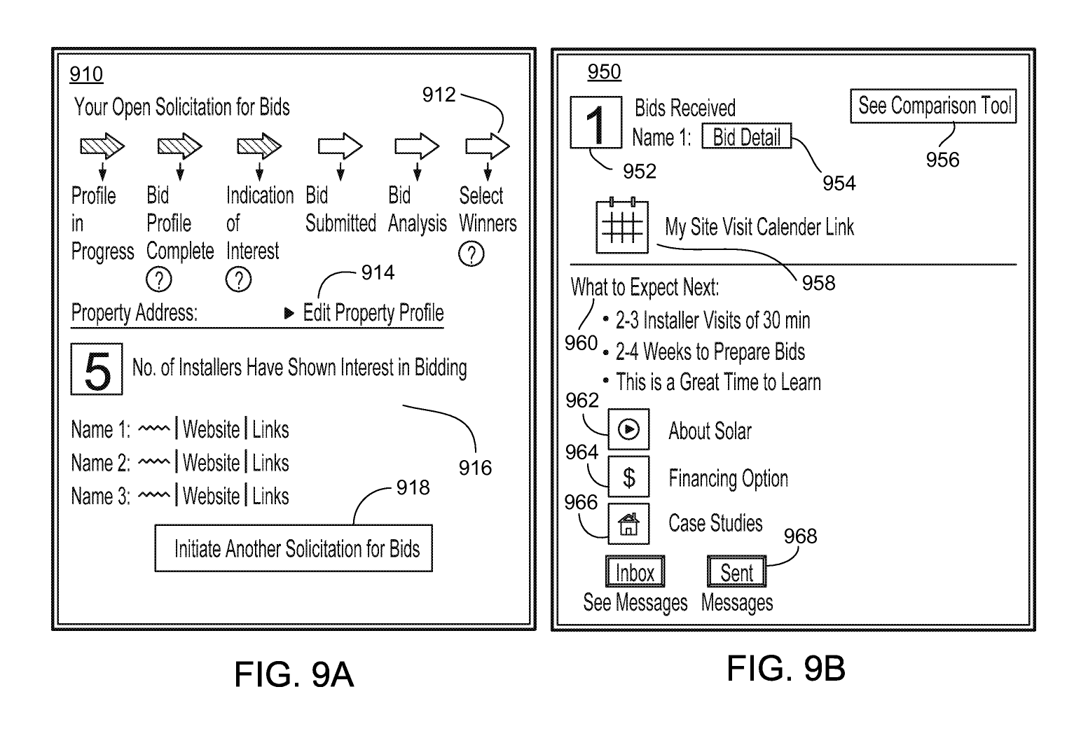

FIG. 9A shows an open solicitation screen 910 of an example dashboard interface for POs, which includes a solicitation status indicator 912 that enumerates and explains the solicitation process steps and indicates which step the open solicitation has reached. The open solicitation screen 910 also includes a listing of interested installers (those who have already indicated interest in the solicitation for quotes) 916 with a total count of interested installers and initiation link 918 for initiating another solicitation for quotes. FIG. 9B shows a quote evaluation screen 950 of the example dashboard interface for POs, which includes a bid (i.e., a quote) listing 952 with a count of quotes received for the solicitation. The quote evaluation screen 950 also includes a link 954 to display further detail on each bid and a link 956 for launching a quote comparison tool. The quote evaluation screen 950 also includes a link 958 to the PO's calendar that may be used to facilitate scheduling of installer site visits.

The quote evaluation screen 950 also includes an explanation of the quote evaluation process 960 and links to educational resources 962, financing options 964, and case studies 966. The quote evaluation screen 950 also includes links 968 to an inbox and sent-messages folder for a platform based messaging system.

A platform administrator may screen the solicitation for quotes to verify that the request has been submitted in good faith and to verify that the energy system type for which solicitations have been solicited is suitable for the property. The platform administrator may request more information from the PO, or decline to process the solicitation for quotes if the administrator concludes, based on the information provided by the PO, that the energy system type for which solicitations have been solicited is not suited for the PO's property or that the solicitation does not represent a genuine intent to purchase an energy system. The platform administrator may communicate with the PO to confirm their interest and ability to install the energy system. The platform administrator may communicate with the PO through a messaging system internal to the platform or through alternative communications channels (e.g., telephone, text, or email).

In some implementations, the administrator dashboard displays and enables the administrator to edit: a list of new solicitations of quotes that have been submitted by POs; a list of all solicitations for quotes; status information, including approval status, for each solicitation for quotes; a queue of all open or active solicitations for quotes that have been approved; statistics summarizing closed solicitations for quotes, including the total, number closed by POs without selecting a winning installer, winning quote counts for various individual installers; a list of newly-registered installers awaiting approval, including tools to approve or respond to an installer; communications between POs and installers; overall platform metrics and graphs (e.g., number of open quotes over time, intents to quote over time, aggregate gross system size sold through the platform, income over time, new POs over time, new installers over time, ratio of installers' intents to quote to open quotes, number of solicitations for quotes ending today, and conversion rates (i.e., percentage of solicitations that convert to selected winners and to installed systems); and billing and invoice status. A list of solicitations for quotes may include an automatically determined technical suitability metric, indicating the likelihood that a solicitation for quotes requests an energy system that is suitable for its corresponding property, to help guide administrators in making approval decisions.

In some implementations, sandbox marketplaces may have sub-administrator dashboards which provide a subset of these features and grant access only to information which belongs to the sandbox participants and transactions. Sub-administrator accounts may be provided to partner organizations to allow partner organizations to track the status of their programs.

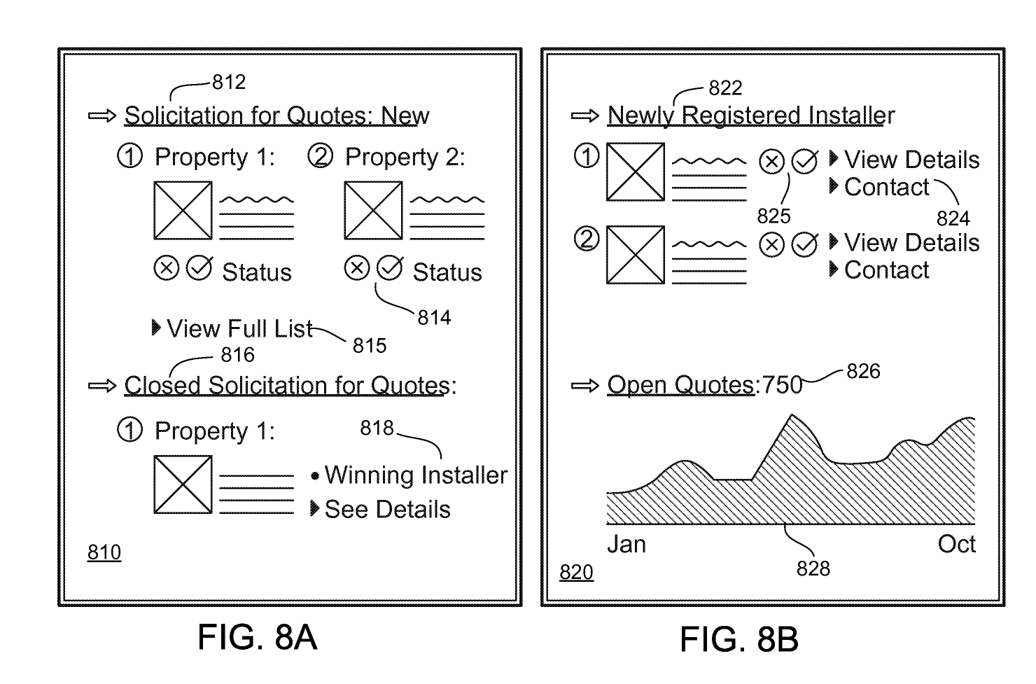

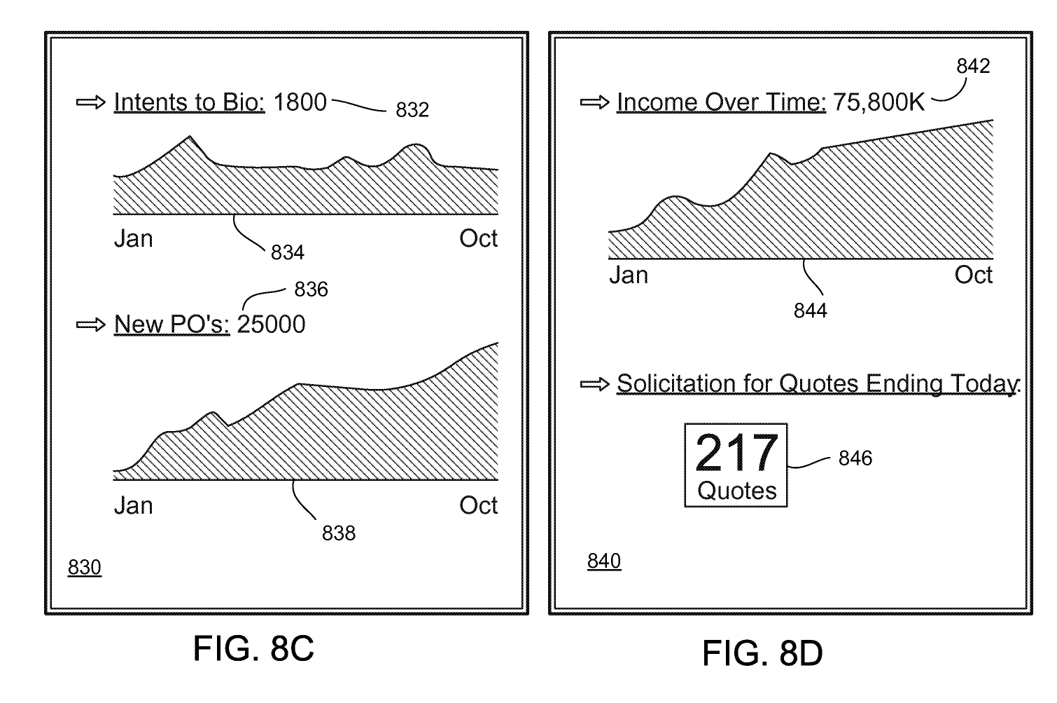

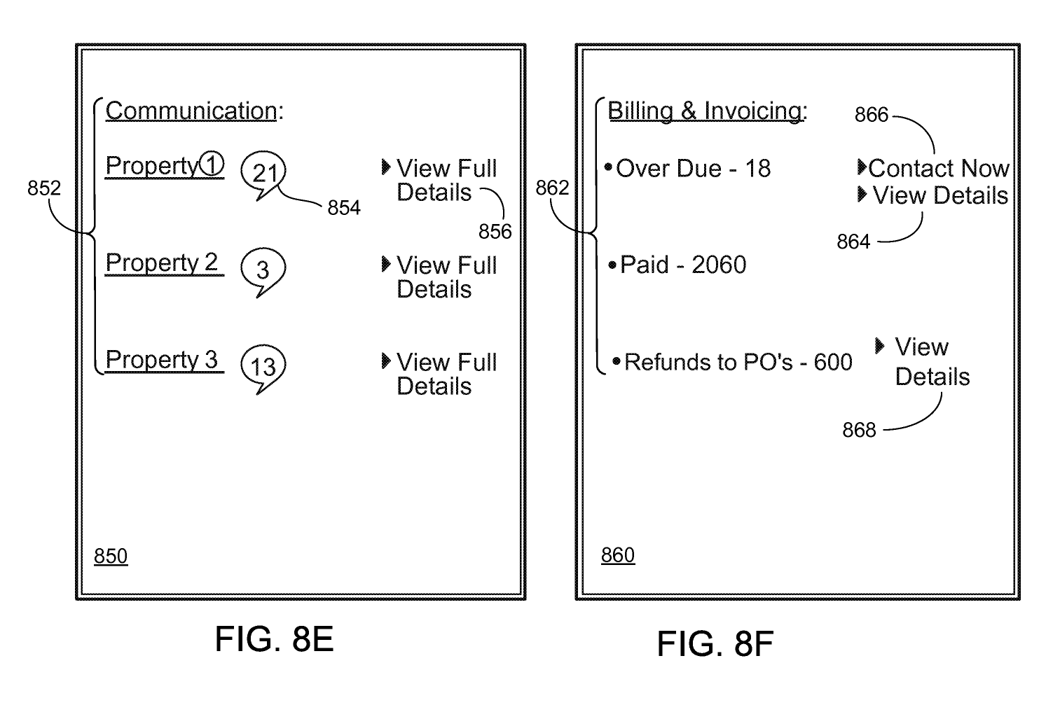

FIG. 8A shows a solicitations review screen 810 of an example administrator dashboard interface, which includes a list 812 of new solicitations for quotes that have been submitted for review. Each new solicitation listing includes basic information about the solicitation with a link to further details and a status indicator icon 814 that allows the administrator to update the approval status of the corresponding solicitation. Controls 815 are provided for customizing the display of large lists. The solicitations review screen 810 also includes a list 816 of recently closed solicitations for quotes. Each of these listings includes an indicator 818 of the identity of the winning installer or an indication that the PO closed the solicitation without making a purchase.

FIG. 8B shows an installer review screen 810 of the example administrator dashboard interface, which includes a list 822 of newly-registered installers that are awaiting vetting and approval. Each installer listing includes links 824 for viewing further details of the registration profile and for contacting the candidate installer. The listings also include a status indicator icon 825 that allows the administrator to update the approval status of the installer (e.g. from candidate installer to approved installer, or approved installer to debarred installer). The installer review screen 820 also includes a current count of open quotes 826 in the platform and a plot 828 of the number of open quotes over time.

FIG. 8C shows an aggregation screen 830 of the example administrator dashboard interface, which includes a current count 832 of intents to submit quotes and a plot 834 of the number of active intents to submit quotes over some specifiable period of time. The aggregation screen 830 also includes a count 836 of new POs recently added to the platform and a plot 838 of the number of new POs over a window of time. FIG. 8D shows a second aggregation screen 840 of the example administrator dashboard interface, which includes a total of recent income 842 for the platform and a plot 844 of the income over some specifiable period of time. The second aggregation screen 840 also includes a count 846 of the number of solicitations for quotes ending today within the platform.

FIG. 8E shows a communications monitor screen 850 of the example administrator dashboard interface, which includes a list 852 of properties subject to quotes. Each property listing includes a count 854 of communications exchanged between the PO for the property and installers that have submitted quotes for the property. Each listing also includes a link 856 that allows the administrator to access further details regarding the exchanged communications. In some implementation, the administrator has access to read the communications.

FIG. 8F shows a billing screen 860 of the example administrator dashboard interface, which includes counts 862 of overdue and paid invoices as well as refunds to POs. The billing screen also includes a link 864 to view details of overdue invoices and a link 866 that allows the administrator to contact installers with overdue invoices to remind them to pay. The billing screen also includes a link 868 that allows the administrator to view details of the transactions that resulted in refunds to POs.

Returning to the example scenario, the information submitted by the PO as part of the solicitation for quotes is made available to a list of solar PV system installers that have previously been vetted and approved by a platform administrator. In some implementations, an email and/or an electronic transmission would be sent to the installers informing them of a newly activated solicitation for quotes. The recipients may be determined based on preferences indicated as part of installer profiles or other criteria as determined by the platform administrator. The platform may offer preferred/priority access to the solicitation for quotes to select installers before presenting the solicitation for quotes to the full pool of installers. The criteria for preferred/priority access may be determined by the platform administrator and may include existing arrangements with a platform administrator, preference indicated by an individual or group of POs, and/or distribution partners.

Installers may access the solicitation profile in a variety of ways. For example, installers may use either a web browser or custom application on their mobile devices to access the listing and indicate their interest in providing a quote. In some implementations, installers access active solicitation information through an installer dashboard interface.

FIG. 6F shows a solicitation list screen 618 of the example GUI for installers, which includes, for each available solicitation for quotes, property information 620 with a link to view further details for the solicitation, an intent to submit bid prompt 622 that allows an installer to announce their interest in bidding to the PO, a count 624 of the number of installers who have already indicated interest in the solicitation for bids, a count 625 of the number of installers who have already submitted a bid, and a link 626 that allows the installer to submit a bid (i.e., a quote) in response to the solicitation. The solicitation list screen 618 also includes a filter function 628 that allows the installer to limit the display to a subset of the available solicitations based on filter criteria (e.g., size, location, or energy bills, etc.). FIG. 6G shows a solicitation detail screen 630 of the example GUI for installers, which displays detailed information 632 about a solicitation for quotes, including name and contact information for the PO, project parameters (e.g., size or location, energy bills, etc.), and the communication requirements of the PO. The installer is prompted 634 to agree to the PO's communication requirements and a link or footnote 635 with details about the regulations relating to the Do Not Call Registry is provided. The solicitation detail screen 630 also displays and/or links to pictures 636 of the property, and provides a mapping tool 638 that may help the installer to locate the property, and assess some of its attributes.

In some implementations, an installer dashboard displays and provides the ability to edit: the installer profile; a form to submit or update a quote for a specific solicitation for quotes; communication history between POs and the installer, including ability to send new messages through the platform; current invoices due, including ability to pay invoices and overdue amounts; subscription status (e.g., priority access to solicitations for quotes and membership in sandboxes or other partitioned markets on the platform); a list of the installer's quotes selected by POs, including the ability to use any successful quote as the foundation for a case study or to invite the PO to post a review and ratings regarding the installer; and reviews and ratings of the installer from POs, including the option to contact POs who submitted them and post rebuttals.

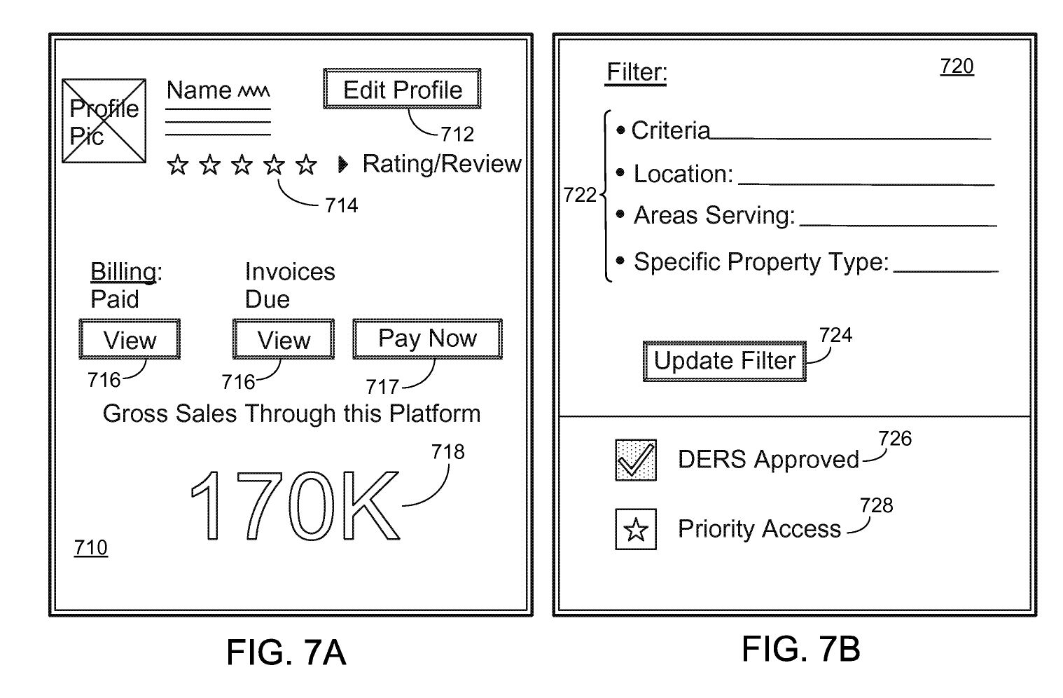

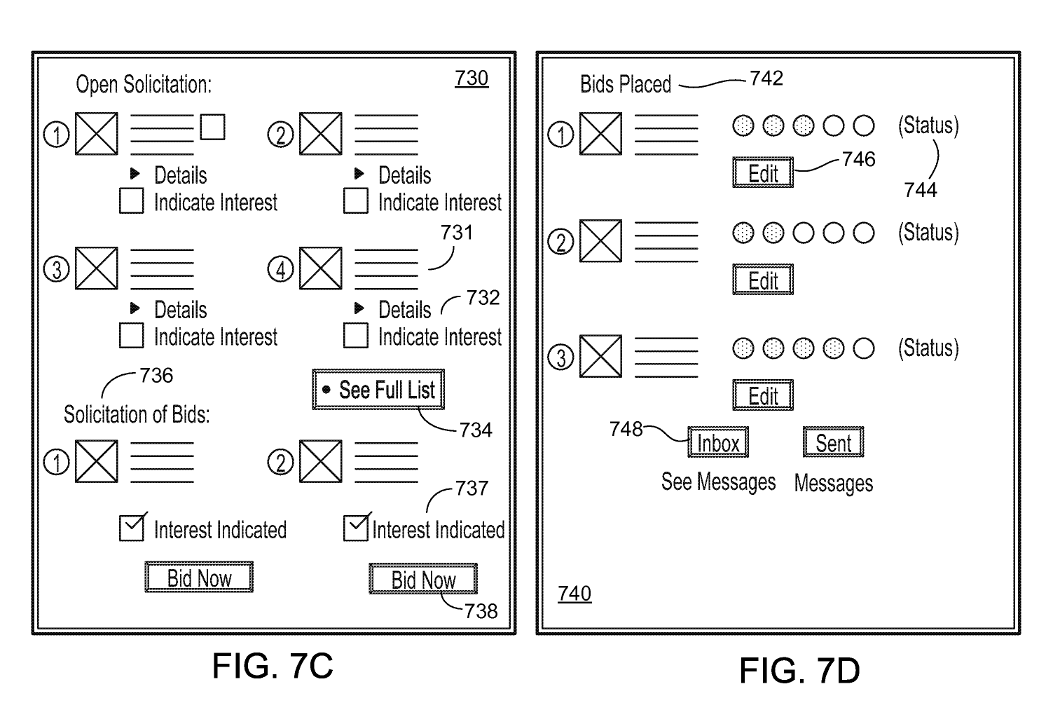

FIG. 7A shows an overview screen 710 of the example installer dashboard interface, which includes profile information with a link 712 to a profile editor. The overview screen 710 also displays billing information 716, including a summary of invoices due and payment history. A payment options link 717 is also provided to facilitate prompt payment. The overview screen 710 also includes a summary 718 of the installer's gross sales through the platform.

In some implementations, an installer dashboard also shows: a list of solicitations open and available for submitting a quote, and other information specific to that solicitation, including but not limited to the number of installers indicating an interest in submitting a quote, the number of installers who have already submitted a quote, the time remaining to submit a quote, etc.; a list of solicitations of quotes for which the installer has indicated interest or intent to submit a quote; a list of solicitations for quotes on which the installer has actually placed a quote, including status. In some implementations, the status information displayed for an active quote may include a rank of the installer's quote relative other active quotes for the same solicitation for quotes based on a number of comparative criteria including, but not limited to price, ratings assigned by the PO, etc.

Installers may be presented with an option to indicate an interest in submitting a quote. An installer will determine if they want to submit a quote. The installer's decision may be based on the type of property, property location, potential size of the system, and other information provided by the PO. Installers may be presented with an option to query the PO and request additional information before submitting a quote or indicating an interest in submitting a quote. Installers may be able to see how many other installers have already indicated an interest in submitting a quote for a given solicitation for quotes or have submitted a quote. A platform administrator or the PO may limit the maximum number of installers that can provide quotes for a solicitation for quotes. In some implementations, the platform may disclose the names of the installers that have indicated interest in submitting a quote in response to the solicitation to all installers with access to the solicitation. The platform may prevent or discourage installers from indicating interest in submitting a quote without actually then submitting one. The platform may determine metrics of installer submissions and indications of intent to submit and may use the metrics to place limits on the installer's access to future solicitations. Installers may be required to acknowledge that if a PO agrees to be contacted via telephone, the expressed written request included in the PO's solicitation for quotes constitutes consent by the PO to be contacted via telephone and/or email, even if the PO's telephone number/email is listed on the National Do Not Call Registry. The installer may be presented with notice that by submitting an indication of interest or intent to submit a quote they acknowledge that the PO's consent to be contacted expires after a fixed period of time (e.g., three months). An installer may be permitted to telephone or email a PO with whom it has an established business relationship for a period of time (e.g., up to eighteen months) after the PO's last purchase, delivery, or payment, even if the PO's number is on the National Do Not Call Registry. Installers may also be presented with notice that they will be solely liable for all violations of the Do Not Call Registry requirements.

FIG. 7B shows a solicitation filter screen 720 of the example installer dashboard interface, which includes a form 722 for entering filter criteria (e.g., geographical areas or property types served) that are used to limit the solicitations presented to the installer through the dashboard to solicitations of interest. An icon 724 allows the installer to update the applied filter with the newly entered criteria. The filter screen 720 also includes an approval status indicator 726 and a priority access status indicator 728, each with a link for requesting status changes.

FIG. 7C shows a solicitation list screen 730 of the example installer dashboard interface, which displays a lists of open solicitations for quotes that meet the installer's filter criteria. The list includes a segregated subset 736 of solicitations for which the installer has indicated interest or intent to submit a quote. Each solicitation in the list includes basic information 731 about the solicitation for quotes with a link to further details and a link or icon 732 that allows the installer to enter an indication of interest in the solicitation. The solicitation list screen 730 also includes formatting controls 734 for customizing the viewing of large lists.

FIG. 7D shows a quotes list screen 740 of the example installer dashboard interface, which displays a list 742 of active bids (i.e., quotes) that the installer has submitted. Each bid in the list 742, includes a status indicator 744 and a link 746 for editing or modifying an offer. The status for a bid reflected in the indicator may include whether the PO has communicated with the installer regarding the bid, whether a site visit has been scheduled or conducted, whether the bid has been accepted, and whether a contract has been submitted or executed. The quotes list screen 740 also includes links 748 to the platform's internal messaging system to facilitate communication with POs to whom offers have been presented.

The PO may be informed of the installers who have indicated an interest in submitting a quote. This may prepare the PO for future contact by those installers during the quote preparation process, including communications (e.g., via a message queue in the platform, telephone, text, or email). The PO may receive a link to a website maintained by the platform administrator that includes a collection of installer profiles. In some implementations, the installer profiles include, but are not limited to: name, address, contact information, website, experience (e.g., years in business or years licensed), certifications, case studies of completed installations, ratings and reviews (including reviews submitted by other POs), etc. The PO may send a message to an interested installer, including asking questions or expressing reservations based on past reviews or other criteria.

FIG. 10B shows an example installer profile view screen 1020 that may be presented to a PO. The installer profile view screen 1020 may allow the PO to consider the qualifications, reviews, and ratings of the installer when deciding which quote to select. The installer profile view screen 1020 displays basic information 1022 about an installer, including a name, logo, years in business, certifications, and contact links that allow the PO to open a communication channel to the installer. The installer profile view screen 1020 also includes links 1024 to case studies for past projects the installer has performed. The installer profile view screen 1020 also includes ratings 1026 (e.g., an average rating from past PO customers) and reviews 1028 from past PO customers of the installer.

FIG. 10C shows an example interest in submitting quote email 1030 that may be sent to a PO, which includes a count 1032 of installers who have indicated interest or intent to submit a quote in response to the PO's solicitation for quotes. The interest in submitting quote email 1030 also includes a list 1034 of installers who have indicated interest in submitting a quote. Each installer listing includes links 1036 to a website, reviews, ratings, and past project case studies for the installer.

An installer may contact the PO to collect additional information or request a site visit. Installer questions may be sent via the platform's internal messaging system to the PO's inbox accessible on the PO's dashboard.

The PO may answer installer questions, provide additional information, and, if requested by installers, arrange for site visits to the subject property. After an installer's question has been added to the PO message system inbox, the PO may also be notified of these communications through electronic channels, including but not limited to, email, texts, and mobile applications. The PO may respond to the questions via the dashboard or directly to the installer via email, telephone or other communication channel. The PO may be presented with an option to keep their communications with the installer private between the PO and the installer who posed or answered a question (and possibly accessible to an administrator as well), or to make the communications accessible to all installers who have expressed an interest in submitting a quote in response to the solicitation for quotes or make it available for viewing by all users of the platform. The PO dashboard may have integrated calendar capability to schedule site visits with installers and share availability and schedule appointments with installers as desired. The calendar scheduling tool may be a proprietary tool or an integrated third-party tool. The PO may update the open solicitation for quotes (e.g., in response to installer questions). Solicitations for quotes that have been updated by the PO may trigger notification messages to all installers who have indicated an interest in submitting a quote and would be flagged as updated in each of the subject installer's list of open solicitations for quotes, either via a timestamp or a graphical icon reflecting the time of the most recent update to the PO's solicitation for quotes.

FIG. 10E shows an example calendar screen 1050 that may be presented to a PO, which includes a calendar icon 1052 that allows the selection of ranges of days (e.g., a month) for editing by the PO. The calendar screen 1050 includes a date prompt 1054 that allows the PO to set indications of days when they are available or unavailable for site visits by installers. The calendar screen 1050 also includes a time prompt 1056 that allows the PO to set indications of blocks of times when the PO is available or unavailable for site visits by installers.

FIG. 6H shows a site visit screen 640 of the example GUI for installers, which includes a calendar interface 642 for selecting a date and/or time for the installer's site visit, a link or icon 644 for submitting a request for a site visit to the PO, and question form 646 that allows the installer to pose questions to the PO via messages sent through the platform's internal messaging system, or via some other communications channel.

An installer submits a detailed quote via the platform. The information contained in the quote can either be manually uploaded by completing a form on the platform via a browser or custom application, or be uploaded automatically via an application programming interface (API) integrated into software tools used by the installer.

Each installer may be prompted to submit the information provided in uniform units to convey information regarding the system they propose to install, including but not limited to: the size of the energy system, its production capacity in standardized units, its efficiency, a detailed cost breakdown, performance, reliability, financial savings, as well as the environmental benefits the energy system is projected to yield. The quote submission form may include mandatory fields and units that are specific to the selected type of energy system or a proposed financing option. The uniform quote submission form may remain consistent across all installers within the scope of a given solicitation for quotes. The installer may specify key contract terms, if needed (e.g., warranties or down payments). The quote may include an estimated date of completion, i.e., when the installer expects the energy system to be commissioned.

For example, a quote for a solar PV system may include: a total installed system cost; a size of the system (e.g., in kilowatts); an annual kWh production estimate or guarantee; a percentage of projected electricity consumption for the property offset by the solar PV system; key assumptions (e.g., derate factor, % shading, azimuth and incline of the installed solar panels, etc.); solar PV panel specifications (e.g., number of panels, efficiency rating of panels, brand of panels, warranty); inverter specifications (e.g., brand, warranty, and type inverter, such as string or micro); monitoring system specifications (e.g., type, brand, subscription cost per year, if any, etc.); total gross cost of the system with breakdown of panel costs, breakdown of cost for power electronics (e.g., inverters or other hardware), and breakdown of non-hardware balance of system costs (e.g., labor cost, permit cost, and other misc. costs); total rebates and incentives, including a list of rebates, federal income tax credit, state tax credit, municipal and other tax credits); net system cost; solar renewable energy credits (SREC) revenue information (e.g., annual revenue and assumptions); projected installation date of the system; and environmental impact (e.g., carbon emissions avoided per year or some other specified period of time).

FIG. 6I shows a quote submission screen 650 of the example GUI for installers, which includes a form 654 with a number of fields that allow the installer to input quote information (e.g., size of energy system, efficiency, detailed cost breakdown, performance, financial savings, environmental benefits, warranties, labor cost breakout, and down payments, etc.) in a standardized format.

The installer may update the quote after initial submission. The PO will be notified of updates and updated quotes will be flagged (e.g., with a timestamp or a graphical icon) as updated in the list of quotes received on the PO dashboard. In some implementations, the platform may inform the installer that their quote does not meet a threshold established by the PO and prompt the installer to revise the quote.

The PO is notified of a newly submitted or updated quote. The platform processes the quote and prepares for it to be displayed in a standardized format. The display may include proprietary and market-standard metrics to allow the PO to evaluate and compare the quote on an apples-to-apples basis with other quotes received. The platform may process the inputs provided by the installer and determine relevant metrics to present to the PO. To determine the values of the metrics, the platform may apply assumptions provided by the installer, the PO, or values determined by a platform administrator (e.g., projected inflation rate of grid-supplied electricity, projected value of SRECs, etc.).

For example, energy system comparison metrics determined for a solar PV system may include: gross installed system cost per kW_{DC} (direct current) and kW_{AC} (alternating current); net installed system cost per kW_{DC} and kW_{AC}; cost of electricity per kilowatt hour (kWh); annual return on investment; internal rate of return (IRR) over the useful life of the system, the term of the lease, if leased, or the term of a PPA, if the owner executes a PPA; total savings over the useful life of the system, the term of the lease, if leased, or the term of a PPA, if the owner executes a PPA; environmental impact expressed in terms of carbon emissions avoided; financing option analyses; monthly loan repayment, or lease payment(s), or PPA payments expressed as cents/kWh; projected monthly savings in electricity bills; net cash flow after loan repayment, etc.

In this example of a solar PV system, the gross installed system cost per kW_{DC} and kW_{AC} is the gross cost of the solar PV system, including all costs to install the system at the property divided by the total system size in Watts (expressed in DC and AC Watts). The net installed system cost per kW_{DC} and kW_{AC} is the net cost of the solar PV system, including all costs to install the system at the property, less all rebates and tax credits and other incentives divided by the total system size in Watts (expressed in DC and AC Watts). For a prepaid lease or prepaid PPA, the upfront prepaid amount is divided by the total system size in Watts (expressed in DC and AC Watts).

In this example of a solar PV system, the cost of electricity per kWh may be calculated (i) for a purchased energy system by dividing the net cost of the energy system by the projected amount of kWh produced by the energy system over its projected life; (ii) for a leased energy system, by dividing the annual lease cost by the projected total kWh produced by the energy system in a year (and if the lease agreement includes an option to purchase, by dividing the sum of the up-front prepaid amount and the purchase option price by the amount of kWh produced over the useful life of the system); and (iii) for a prepaid lease or prepaid PPA, by dividing the up-front prepaid amount by the projected amount of kWh produced by the energy system over the lease or PPA term (and if the PPA includes an option to purchase, by dividing the sum of the up-front prepaid amount and the purchase option price by the amount of kWh produced over the useful life of the system).

In this example of a solar PV system, the annual return on investment (ROI) may be calculated by first summing the total value of electricity produced in a year and the net revenue from selling solar renewable energy credits (SRECs) in a year. This sum is divided by either the net cost of the solar PV system purchased or, for a prepaid lease or prepaid PPA, the up-front prepaid amount. The net cost of the solar PV system is calculated by deducting from the gross cost of the system all discounts, rebates, tax credits, depreciation benefits, and other benefits accruing to the PO.

In this example of a solar PV system, the internal rate of return (IRR) may be calculated over the useful life of the system, or term of the lease agreement or PPA. IRR is a financial metric that is used to measure and compare the profitability of investments. In the example of a solar PV system, IRR is calculated by taking into account the net cost of the system purchased or the upfront prepaid amount (in case of a prepaid lease or prepaid PPA) and the annual savings resulting from the sum of total value of electricity produced in a year and net revenue from selling Renewable Energy Credits in a year.

In this example of a solar PV system, the total savings over the useful life of the system, or the term of a lease or PPA may be calculated by summing up the total value of electricity produced and the net revenue from selling SRECs over the useful life of system, or the term of a lease or PPA and other tax benefits (e.g., depreciation).

In this example of a solar PV system, the environmental impact may be calculated based on the projected kWh produced by the energy system per year and may be reported in terms the following analogs: pounds or tons or other weight measure of carbon emissions avoided per year; equivalent number of trees planted to absorb the total carbon avoided per year; and equivalent number of oil barrels used to generate a corresponding amount of electricity, or some other measure of avoided carbon emissions.

In this example of a solar PV system, the financing option analysis may demonstrate the financial impact and cash flow impact of the PO borrowing to either purchase the energy system outright, or prepay a lease agreement or PPA.

In this example of a solar PV system, the monthly loan repayment may be calculated based on term of the loan and interest rate provided to the PO, or averages provided by banks The projected monthly savings in electricity bills may be calculated by summing up the total value of electricity produced and the net revenue from selling SRECs. The net cash flow after loan repayment may be calculated by subtracting the monthly loan repayment from the projected monthly savings in electricity bills.

The display reflecting the quote submitted by the installer may be presented or made available to the PO and administrators with access. In some implementations, the quote information may be made available to all participating installers as determined by the platform administrator or the PO.

The PO accesses the quotes submitted by one or more installers in the standard format rendered by the platform. The standardized format of displaying quotes may allow the PO to get detailed information regarding the equipment (including brands, warranty, quality rating, etc.) and other energy system costs, including but not limited to, hardware, labor, permitting, and other non-hardware balance of system costs, etc. The quote presentation format may display standardized metrics, both prevalent in the industry and proprietary to the platform. Using a standard presentation format may allow the PO to compare quotes on a uniform “apples-to-apples” basis and to see how each installer breaks down their prices for hardware, labor, permitting, and other non-hardware balance of system costs, etc. The submitted quotes may only be available for review by the PO who issued the solicitation and by platform administrators. In some implementations, the quote information may be made available to all participating installers as determined by the platform administrator or the PO.

For example, competing quotes for a solar PV system may be displayed in a table with columns for each competing quote. The rows of the table may have various information fields and metrics that are used to compare the quotes. The rows of the example table may include: the total installed (i.e. gross) system cost; the size of the system (e.g., in kW); an annual production estimate or guarantee; a percentage of projected electricity consumption for the property offset by the solar PV system; key assumptions (e.g., derate factor, % shading, azimuth and incline of the installed solar panels); solar PV panel specifications (e.g., number of panels, efficiency rating of panels, brand of panels, warranty); inverter specifications (e.g., brand, warranty, and type inverter, such as string or micro); monitoring system specifications (e.g., type, brand, subscription cost per year, if any); total gross cost of the system with breakdown of panel costs, breakdown of cost for power electronics (e.g., inverters or other hardware), and breakdown of non-hardware balance of system cost (e.g., labor cost, permit cost, and other miscellaneous costs); total rebates and incentives, including list of rebates, federal income tax credit, state tax credit, and municipal and other tax credits, if any); net system cost; SREC revenue information (e.g., annual revenue and assumptions); projected installation date of the system; and environmental impact (e.g., carbon emissions avoided per year); standard metrics for comparison (e.g., gross and net installed system cost per kW, cost in $/kWh of electricity produced by the solar PV system, annual return on investment, IRR over the useful life of the system, or the term of a lease agreement or PPA, and total savings over the useful life of the system, or the term of a lease agreement or PPA); and financing option analysis (e.g., monthly loan repayment, monthly savings, net cash flow).

FIG. 5H shows [EJK2][EJK3] a quote comparison screen 526 of the example GUI for POs, which includes a table with columns 527 for each installer that has submitted a quote in response to the solicitation for quotes. The table has rows 528 for displaying in a standard format various information fields and standard metrics (e.g., energy system brand, installer average rating, quality metric, warranty information, total costs, labor costs, permit costs, and hardware costs).

In the example of a solar PV system, a quote comparison display may include multiple tables, with a separate table for each financing option (e.g., outright purchase, pre-paid lease or PPA, $0-down lease or PPA, custom down-payment lease or PPA, etc.).

In the example of a solar PV system, the platform may include additional tools to help the PO evaluate and analyze competing quotes, pricing and financing options. In some implementations, a solar quote evaluation tool helps the PO choose whether it is more advantageous to purchase the solar PV system, or to finance the PV system by means of third-party financing options, including but not limited to a leasing agreement, PPA, etc., and to evaluate competing quotes for each such financing alternative. In the example of a solar PV system, the tools will also let the PO run hypothetical scenarios by adjusting underlying assumptions (e.g., SREC value, grid-supplied electricity price inflation rates, etc). The platform may provide guidance on the assumptions to be modified and values used in hypothetical scenarios. Quotes may receive an algorithmic score that combines several other metrics (e.g., cost, quality of materials, installer ratings, responsiveness, past history using the platform) into an aggregate confidence or recommendation score. For example, each relevant metric may be assigned a weighted coefficient. For each bid, a value for each of these metrics would be multiplied by the corresponding coefficient and a sum calculated. This would be scaled to a common range (e.g., 1 to 100) for use as an aggregate confidence score. The PO may be provided with the ability to sort the quotes in a display based on various criteria. In the example of a solar PV system, the sorting criteria may include, but are not limited to: standard metrics (e.g., total installed cost per kW); gross cost; lifetime benefit; installer ratings; on-time installation rate; and cost per kWh of electricity produced by the solar PV system; and confidence score. FIG. 5I shows a quote evaluation tool 530 of the example GUI for POs, which generates, plots, and displays expected financial benefit accumulation over time for multiple competing bids (i.e., quotes). This tool may help a PO compare how the return on investment in the energy system will be realized over time in the different scenarios proposed by the quotes. For example, the quote evaluation tool 530 may be used to compare the relative financial benefits over time of owning a solar PV system, leasing it, executing a PPA, or some other financing option.

The PO may be given an opportunity to pose questions directly to installers that have submitted quotes for the PO's solicitation via the installers' dashboards, and compare installer responses. The questions may be posed to one individual installer or to all installers that have submitted quotes in response to the solicitation for quotes. These questions and replies to the installers may, at the PO's discretion, be kept private, made public, or shared with all the installers submitting quotes.

FIG. 10D shows an example installer communication log 1040 that may be presented to a PO, which displays a sequence of communications exchanged between the PO and an installer. The installer communication log 1040 starts with an installer question 1042, then displays the PO's answer 1044, and the installer's response 1046. Icons 1048 are provided that allow the PO to select whether the communication log will be kept private (e.g., only the PO and possibly an administrator may see the log) or made public and accessible to other users of the platform (e.g., installers or other POs). Messages listed in the log include ‘helpful’ and ‘not helpful’ icons 1043 that allow platform users viewing the log to rate the message to indicate whether they found it useful. A rating of each message, based on clicks on these rating icons 1043 by users (e.g., percentage of voters finding the message helpful), may be displayed in the log or used to sort or select messages for display.

The platform may include tools to help the PO decide whether to borrow to pay for the energy system. In some implementations, the platform helps the PO determine their net cash flows, net savings, amortization tables for loans, etc., based on various loan scenarios.

The PO selects a winning quote, that is, one that the PO wishes to purchase. The platform may provide the PO with the capability to research profiles of each installer submitting quotes and research proposed brands of equipment. In some implementations, the PO is not be required to accept the lowest-priced quote, and could accept a higher priced quote solely at the PO's discretion. For example, a PO may choose a higher priced quote if they determine that an installer submitting a higher-priced quote offered more experience, better rated brands, a higher level of service, etc. FIG. 5J shows a quote selection screen 540 of the example GUI for POs, which includes a listing 542 of the competing quotes with links to detailed information on each and icons that allow the PO to indicate their ultimate selection. By clicking a confirmation link 544, the PO may finalize the selection of the winning quote and end the reverse auction.

The winning installer may be notified that a PO has selected its quote and wishes to execute a contract via the platform's internal messaging system and/or alternative electronic communication channels. The PO may choose not to accept any quote (i.e., not to choose a winner) and close the solicitation for quotes for any reason at any point during the solicitation process. If a non-refundable deposit was made, that deposit will be forfeited. The installers who had indicated an interest in submitting a quote will be notified via electronic channels and the solicitation for quotes will be removed from the list of open solicitations on the platform and all installer dashboards. The PO may reopen a solicitation for quotes previously closed. The platform may retain previously uploaded information for specifiable periods of time (e.g., 6 months or 1 year) as determined by the platform administrator. The PO may update the solicitation profile, as needed, with the more current information.

The winning installer prepares a contract including the terms specified in the winning quote. The winning installer uploads the contract for presentation to the PO and execution. The winning installer signs the contract (e.g., manually signs a paper copy and scans for upload or transmission, e-signs with an electronic authentication certificate, or e-signs in some other manner). The PO is informed via electronic communication channels (e.g., via the internal messaging service of the platform) of the availability of the installer's contract for execution. The PO may pose questions or request modifications to contract terms via return communications. The winning installer may update the contract and upload a modified version. The contract or revised contract is delivered to the PO and the PO signs the contract either electronically or in hard-copy. In some implementations, the platform may integrate with third-party or proprietary electronic signature tools (e.g., EchoSign).

FIG. 6J shows an acceptance screen 660 of the example GUI for installers, which notifies the installer that their quote has been accepted and includes a links for uploading a contract for the project 662, reviewing details of the quote 664, and electronically signing the contract 666. FIG. 6K shows a contract screen 670 of the example GUI for installers, which includes a display 672 of the contract terms. The PO may ask questions and request modification of the contract in some cases and the interface allows the installer to make accommodating modifications to the contract. The contract screen 670 includes links for updating the contract 676, uploading a modified version of the contract 678, and downloading the final signed contract 674.

FIG. 5K shows a contract review screen 550 of the example GUI for POs, which includes a display 552 of the contract terms and a sign button 556 that allows the PO to electronically sign the contract if it is acceptable. The contract review screen 550 also includes a link 554 that allows the PO to download a copy of the contract.

When the contract is signed electronically, an electronic copy of the contract is delivered electronically to both the PO and the winning installer. Electronic copies of contract may be presented through the PO dashboard and the installer dashboard.

Upon execution of the contract the winning installer may be invoiced by the platform administrator for services fees. The winning installer may be notified via electronic communication channels (e.g., email or a messaging system hosted on the platform). The installer and administrator dashboards may be updated with the new invoice and billing information. The winning installer may pay the invoice in a variety of ways. For example, payment options include check, credit card, PayPal transfer or other electronic funds transfer (EFT). In some implementations, installers may be required to maintain a credit balance with the platform against which the platform service fees may be deducted.

After execution of the contract, the installer proceeds to install the energy system selected in accordance with the terms of the contract. The energy system is installed the property identified in the contract, is installed on behalf of the property owner, and is then used by the property owner for energy related purposes.

FIG. 6L shows an invoice screen 680 of the example GUI for installers, which includes a display an itemized bill 682, invoice status information 684 (e.g., pending date or paid date), and a link 688 to payment options screen. The invoice screen 680 may also include links 686 to property details and quote details for the project invoiced.

The PO may be prompted to publish a project profile (i.e., a case study) and provide ratings and reviews on the platform for the winning installer, financier, manufacturers of brands of energy system selected or installed, etc. For example, when the project's estimated date of completion has passed, the platform will automatically contact the PO for status of the energy system, e.g., whether it has yet been commissioned. If not, the PO may be asked to update the estimated date of completion and/or to submit to the platform feedback about the experience working with the installer(s). For commissioned systems, the platform may prompt the PO to create a profile of their property and the installed energy system for publication on the platform. The information about the property and energy system already captured by the platform during the solicitation for quotes process may be used to pre-populate fields in a template form for the project profile. The PO may edit the form and provide additional profile details. This case study (i.e., profile of the energy system installation and the property) will be posted on the platform and provide future POs with price and other information they can use to evaluate their quotes. The case study may provide a testimonial for the installer and/or brands of equipment that were employed. The PO may be notified that any information they post will be published publicly, and that if they wish to keep information private (e.g., their street address) it should not be uploaded to the platform as part of the project profile.

FIGS. 5L-5M show an example display of a case study in the example GUI for POs. FIG. 5L shows a first portion 560 of the case study display that includes identification and contact information 562 for the poster or source (e.g., another PO) of the case study as well as links to share the case study via social media and other communication channels. The first portion for the display 560 also includes information about the property 564, the technology employed 566, and the financing details for the project 567 as well as a ‘what you need to know’ section 568 displaying a concise summary of the project and the outcome experienced by the poster. The second portion 570 of the display, shown in FIG. 5M, includes information regarding the brands 572 of the energy system components deployed, the installers employed 574, and financiers engaged 575. The second portion 570 of the display also includes quick facts 576 summarizing the financial outcome of the profiled project links with thumbnails 578 to images of the project.

The platform will prompt the PO to provide feedback and testimonials about the solicitation for quotes process and the platform features and capabilities. The platform may also prompt installers to submit feedback about their experience with the platform and a particular solicitation for quotes process and resulting project.

The platform may collect and report on relevant platform performance metrics privately or on a public website. These performance metrics may reflect the effectiveness of the solicitation for quotes processes conducted on the platform (e.g., conversion ratios, close rates, etc.).

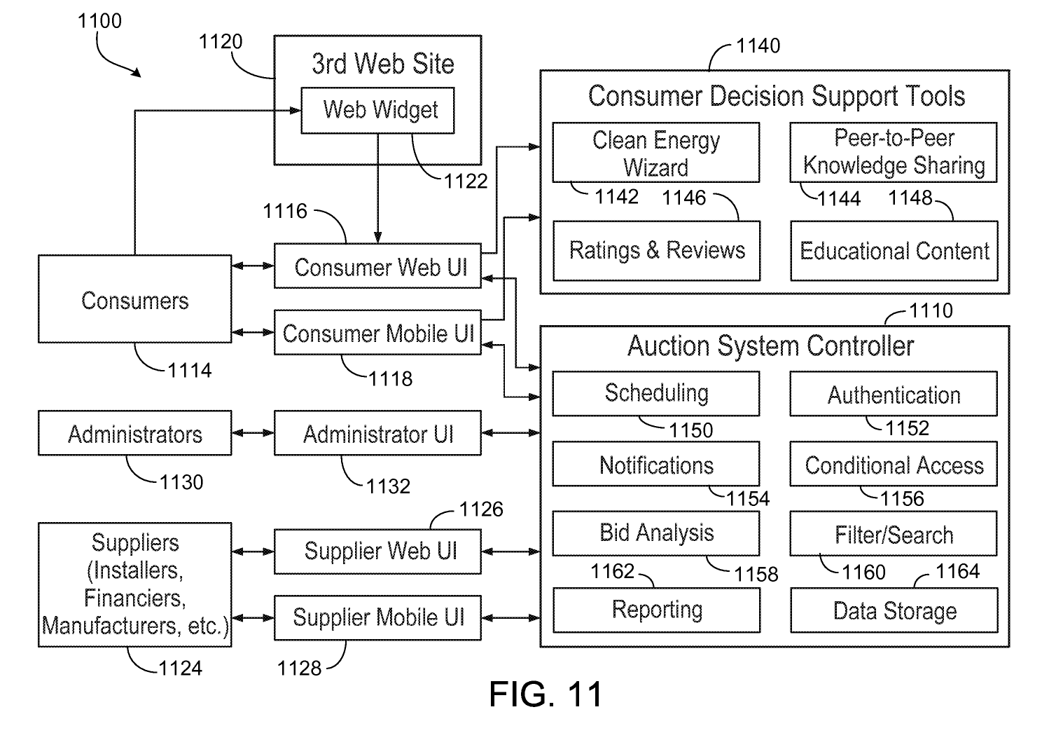

FIG. 11 is a block diagram of an example online environment 1100 including a platform 1110 configured to facilitate the purchase of an energy system for a property. Online environment 1100 also includes consumers 1114 (e.g., POs) that access data and services provided by the auction system controller 1110 via communications over an electronic network (e.g., a local area network (wired or wireless), wide area network, the Internet, or a combination thereof.).

A consumer 1114 exchanges communications with the auction system controller 1110 through a consumer web user interface 1116 or a consumer mobile user interface 1118, depending on the user device the consumer uses to send and receive network communications (e.g., personal computers, mobile communication devices, and other devices that can send and receive data over the network). A user device typically includes a user application (e.g., a web browser or mobile application) to facilitate the sending and receiving of data over the network and the presentation of content to a user. For example, a PO may use a smartphone to access the consumer mobile user interface through a network and thereby access services offered by the auction system controller 1110. In some implementations, a consumer web user interface 1116 or a consumer mobile user interface 1118 is secured by an authentication protocol or service and/or allows for personalization for individual consumers (e.g., the user interface recognizes a particular consumer and saves an interface configuration state that may be recovered for subsequent sessions with the same consumer).

The network environment also includes suppliers 1124 (e.g., installers) who access data and services provided by the auction system controller 1110 through network communications. A supplier 1124 exchanges communications with the auction system controller 1110 through a supplier web user interface 1126 or a supplier mobile user interface 1128, depending on the user device the supplier uses to send and receive network communications. For example, an installer may use a tablet device to access the supplier mobile user interface through a network and thereby access services offered by the auction system controller 1110. In some implementations, a supplier web user interface 1126 or a supplier mobile user interface 1128 is secured by an authentication protocol or service and/or allows for personalization for individual suppliers.

The network environment also includes one or more administrators 1130 of a platform including the auction system controller 1110. An administrator accesses the auction system controller 1110 through an administrator user interface 1132 and they generally have a higher level of permissions to configure and access data in the auction system controller 1110 than a consumer. In some implementations, the administrator user interface 1132 is a terminal directly connected to a server running the auction system controller 1110. In some implementations, the administrator user interface 1132 is software running on a server system that the administrator accesses over a network using a user device (e.g., a personal computer running a web browser client).

The network environment also includes consumer decision support tools 1140 that are accessed by consumers over a network and facilitate user decision making at key steps in the energy system acquisition process (e.g., selection an energy system or type of energy system and selecting a quote). Consumers may also exchange communications with consumer decision support tools 1140 through a consumer web user interface 1116 or a consumer mobile user interface 1118. The consumer decision support tools 1140 include an energy system wizard 1142 (e.g., a DCE system wizard), peer-to-peer knowledge sharing 1144 (e.g., online discussion boards and wikis), supplier ratings and reviews 1146 (e.g., submitted by other consumers), and educational content (e.g., scientific literature, environmental regulations, construction/building codes, images, and instructional videos).

A consumer 1114 may begin the solicitation transaction via multiple entry points. In addition to the entry point on the consumer web UI 1116 and consumer mobile UI 1118, there may exist on various 3rd party websites 1120 with web widgets 1122 that include an initial form where the consumer may begin the process of entering their solicitation for quotes. For example, an environmental advocacy web site 1120 could include a web widget 1122 on their site to allow their members to begin the solicitation for quotes process directly from their site.

The auction system controller 1110 may provide many of the services offered to consumers and suppliers by the platforms described here. In this example, the auction system controller includes modules that provide authentication 1152 of consumers and suppliers using a platform, conditional access 1156 to data (e.g., solicitations in a sandbox or subject to priority access by certain suppliers), notifications 1154 of events (e.g., installer approval, solicitation for quotes approval, interest indications, quote submissions, quote acceptances), automated scheduling 1150 of key process events such as the end of the period during which quotes may be submitted in response to a particular solicitation, bid (quote) analysis 1158 to confirm viability and facilitate comparison to competing quotes, filter/search 1160 (e.g., to focus lists of solicitations or quotes), reporting 1162 (e.g., of platform performance summary metrics), and data storage 1164 (e.g., of supplier profiles and solicitation profiles).

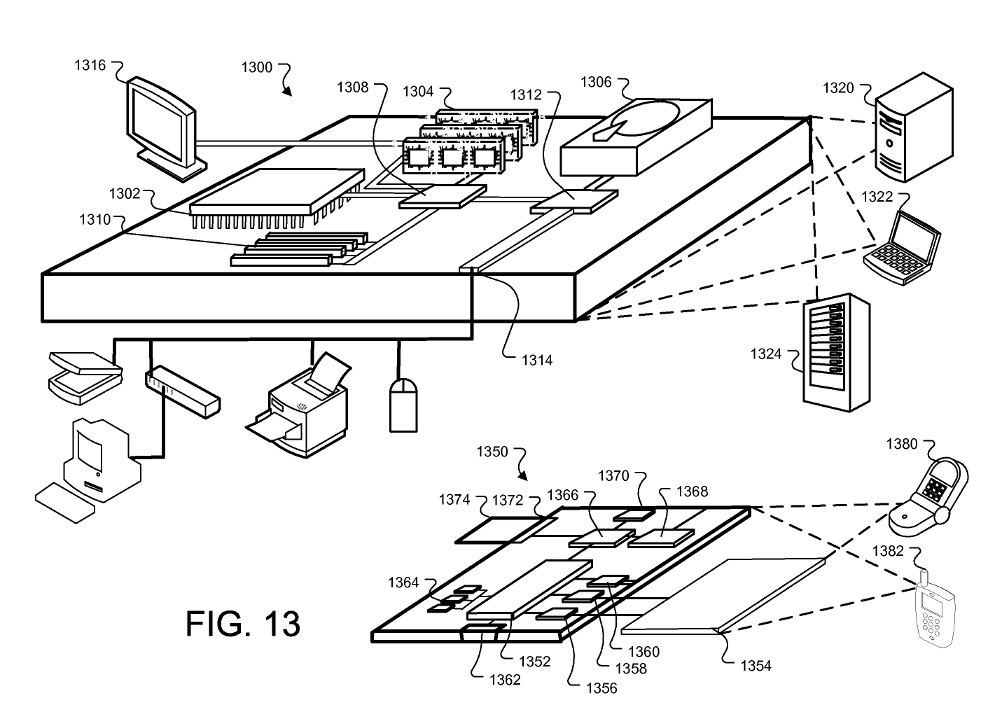

The auction system controller 1110 may be implemented as software that is executed on a processing apparatus, e.g., a computer system described in FIG. 13. One or more server system interface components of the auction system controller 1110 may be used to transmit notifications to and receive submissions from POs, installers, or administrators. The consumer decision support tools 1140 may also be implemented as software that is executed on a processing apparatus, e.g., a computer system described in FIG. 13. In some implementations, an auction system controller and consumer decision support tools may be implemented on the same processing apparatus.

The consumer web user interface 1116, the consumer mobile user interface 1118, supplier user interface 1126, supplier user interface 1128, and administrator user interface 1132 may be implemented as software that is executed on a processing apparatus, e.g., a computer system described in FIG. 13. In some implementations, the consumer web user interface 1116, the consumer mobile user interface 1118, supplier user interface 1126, supplier user interface 1128, and administrator user interface 1132 may be implemented on the same processing apparatus as the auction system controller 1110 and/or the consumer decision support tools 1140.

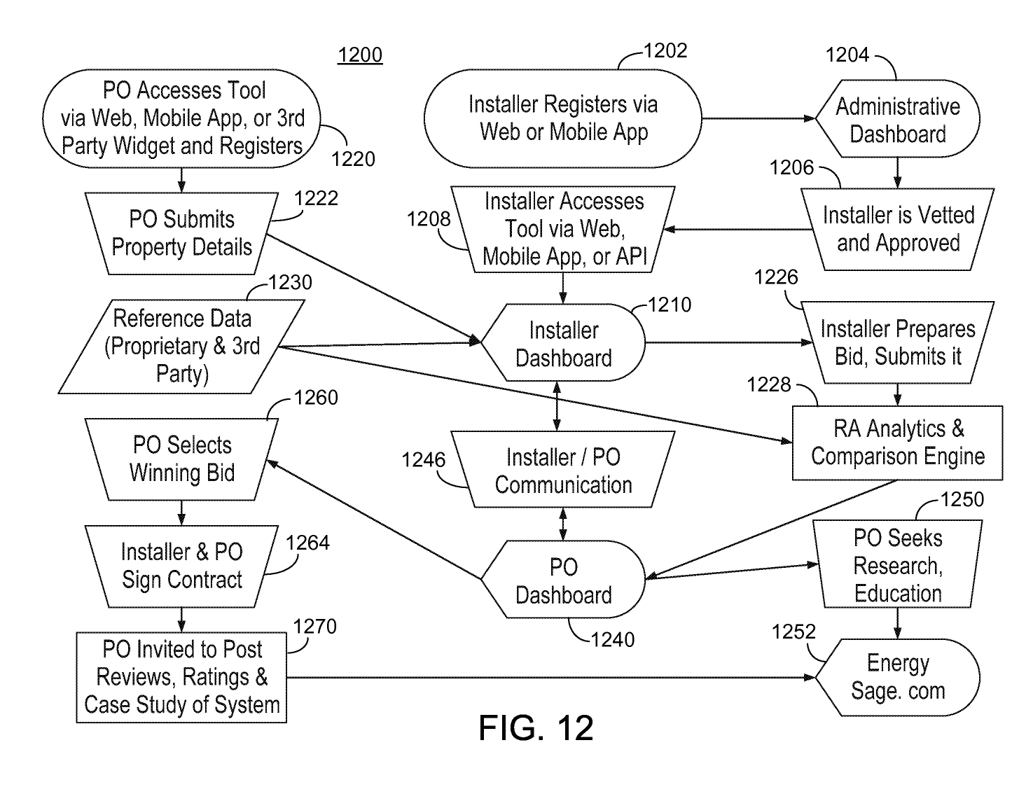

FIG. 12 is flow chart of an example process 1200 for facilitating the purchase of an energy system for a property. An installer registers 1202 with a platform and an administrator uses their dashboard interface 1204 to access the installer's profile data and vets and approves 1206 the installer. The installer accesses 1208 the platform through the mobile interface using a mobile application running on a mobile user device or the web interface using a web browser on a computer or mobile device. The installer may then use their installer dashboard interface 1210 to further update their installer profile and review available solicitations for offers.

A PO accesses 1220 the platform and registers through a consumer web user interface and/or a consumer mobile user interface using a web browser or a mobile application running on a user device. The PO submits 1222 property details along with a solicitation profile to request the placement of a solicitation for quotes on the platform. In some implementations, the PO utilizes a energy system wizard to help them select the energy system of type of energy system they want for the property and will specify in the solicitation for quotes.

The installer receives notification 1210 of the new solicitation for quotes through their installer dashboard interface. The installer indicates interest in the solicitation, prepares a quote and submits 1226 the quote in response to the solicitation. The quote may be based in part on reference data 1230 (e.g., historical utility rates, interest rates weather records, or weather predictions) that the installer accesses 1210 using their installer dashboard interface.

The quote is analyzed 1228 based in part on reference data 1230 and presented to the PO in a standardized format with standardized metrics through their PO dashboard interface 1240. The PO uses the dashboard interface 1240 to view tables presenting a multiple offers for comparison in the standardized format. The PO may communicate 1246 with the installer or other competing installers to ask questions or request quote modifications. In some implementations the installer and PO dashboard interfaces support a messaging service internal to the platform to facilitate these communications 1246. The PO may also seek research and educational materials 1250 to help them interpret the standardized data for the quotes and make a decision. Research 1250 may be conducted with consumer decision support tools linked to from the PO dashboard interface. For example, educational materials and installer ratings and reviews may be retrieved 1252 from a website (e.g., a website hosted by the platform administrator).

When the PO decides which quote they prefer, the PO may use the PO dashboard interface to select 1260 the winning quote (i.e., bid). The winning installer may then propose a contract, which may be subject to some further negotiation and modifications, and the installer and the PO electronically sign 1264 the final contract.

After the agreed project is scheduled to be completed, the PO may be invited 1270 to post reviews, ratings, and/or a case study of the energy system, the installer(s), and the solicitation of quotes process.

The process 1200 can be implemented, for example, by the auction system controller 1110 of FIG. 11. In some implementations, the auction system controller 1110 is a data processing apparatus that includes one or more processors that are configured to perform actions of the process 1200. For example, the data processing apparatus may be the apparatus 1300 described in FIG. 13. In some implementations, some of the steps in process 1200 may be pushed out to a client device, e.g., a user device. For example, the mobile device 1350 described in FIG. 13 may be a user device that generates and displays table with standardized format for comparing competing quotes. In some implementations, a non-transitory computer readable storage medium can include instructions that when executed by a computing device (e.g., a computer system) cause the device to perform actions of the process 1200.

FIG. 13 shows an example of a generic computer device 1300 and a generic mobile computing device 1350, which may be used with the techniques described here. Computing device 1300 is intended to represent various forms of digital computers, such as laptops, desktops, workstations, personal digital assistants, servers, blade servers, mainframes, and other appropriate computers. Computing device 1350 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1300 includes a processor 1302, memory 1304, a storage device 1306, a high-speed interface 1308 connecting to memory 1304 and high-speed expansion ports 1310, and a low speed interface 1312 connecting to low speed bus 1314 and storage device 1306. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, memory on processor 1302, or a propagated signal.

The high speed controller 1308 manages bandwidth-intensive operations for the computing device 1300, while the low speed controller 1312 manages lower bandwidth-intensive operations. Such allocation of functions is exemplary only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provide in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provide as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, memory on processor 1352, or a propagated signal that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, WiFi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular telephone 1380. It may also be implemented as part of a smartphone 1382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used here, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The features of a graphical user interface may be organized and displayed in one or more screens, windows, or views. In some implementations, features of an example screen described here may be split across multiple screens within the user interface or features from multiple screens may be combined in to a single screen, as appropriate for display on a particular user device (e.g., for personal computer with a 21 inch monitor or a smartphone with a 4 inch display).

The logic flows depicted in the figures do not require the particular order shown, or sequential order, to achieve desirable results. In addition, other steps may be provided, or steps may be eliminated, from the described flows, and other components may be added to, or removed from, the described systems.

Other implementations are also within the scope of the following claims.

1. A computer-implemented method comprising
providing an online interface in which a property owner enters information defining a specification of an intended energy system to be installed for the property owner,
the specification being in sufficient detail to enable each of two or more different installers to provide commercial offers of an energy system that conforms to the specification.

2. The method of claim 1 in which the commercial offers comprise offers in a form ready for acceptance.

3. The method of claim 1 in which the specification comprises information identifying a location of the property, consumption of energy at the property, and current energy costs.

4. The method of claim 1 comprising enabling the property owner through the online interface to enter into a commercial transaction for one of the energy systems by accepting the commercial offer for the energy system.

5. The method of claim 1 comprising prompting the property owner in the online interface for each one of a set of specific items of information that together will be sufficient to define the specification.

6. The method of claim 1 comprising
electronically transmitting copies of the same defined specification to two or more different installers to solicit offers from them for energy systems that conform to the specification.

7. The method of claim 4 in which the offers are in a form ready for acceptance.

8. The method of claim 1 comprising
receiving the commercial offers including parameters of the offers and presenting the offers including the parameters to the property owner through the online interface.

9. The method of claim 1 comprising
presenting financing options applicable to the commercial offers.

10. The method of claim 1 in which the commercial offers are provided by the installers through an online system.

11. The method of claim 1 in which the online interface comprises a dashboard that gives access to information about the intended energy system, the specification, the installers, and the commercial offers submitted to the property owner.

12. The method of claim 1 in which the online interface enables the property owner to communicate using text, images, video, or documents with one or more of the installers.

13. The method of claim 1 in which the online interface enables the property owner to define preferences with respect to the commercial offers.

14. The method of claim 13 in which the preferences include a limit on the number of commercial offers to be permitted for the specification.

15. The method of claim 1 in which the online interface provides information that suggests relative desirability for the property owner of two or more of the commercial offers or of the installers or of both.

16. The method of claim 1 in which the online interface provides ratings and reviews of installers and marketing information provided by the installers.

17. The method of claim 1 in which the online interface enables the property owner to share with others a case study based on the specification and other information related to the intended energy system subsequent to installation.

18. The method of claim 1 in which the information defining a specification includes information derived from the property owner by a guided sequence of interactive steps in each of which the property owner is prompted to enter information associated with energy systems of interest to the property owner, the content of at least one of the later steps being dependent on the information entered by the user in a prior step.

19. The method of claim 1 in which the online interface is provided through a mobile application or a website.

20. The method of claim 1 in which defining a specification of an intended energy system includes defining parameters relating to and attributes of a property of the property owner.

21. A computer-implemented method comprising
providing an online interface that presents to a property owner parameters defining two or more offers each to install an energy system that conforms to a common specification of an energy system, the parameters of the offers being expressed in common comparable units.

22. The method of claim 21 in which the common comparable units comprise standardized metrics for energy systems.

23. The method of claim 21 in which the online interface enables the property owner to compare the two or more offers using the common comparable units.

24. The method of claim 21 in which the online interface enables the property owner to express or change assumptions that underlie the two or more offers and to have the expressed or changed assumptions applied automatically to all of the two or more offers to produce altered offers that can be compared based on the common comparable units.

25. The method of claim 21 in which the interface presents the parameters defining the two or more offers simultaneously to the property owner.

26. The method of claim 21 in which the online interface is provided through a mobile application or a website.

27. A computer-implemented method comprising
providing an online interface that presents to a property owner interactive tools that enable the property owner to compare or rank two or more offers each to install an energy system that conforms to a common specification previously expressed by the property owner.

28. The method of claim 27 in which the two or more offers are expressed in common comparable units.

29. The method of claim 27 in which the two or more offers are presented simultaneously for comparison or ranking.

30. The method of claim 27 in which the property owner can select one or more criteria with respect to which the two or more offers are to be compared or ranked.

31. The method of claim 27 in which the online interface is provided through a mobile application or a website.

32. A computer-implemented method comprising
providing to potential installers of energy systems an online interface that enables them to submit information to be stored at a server and presented to property owners in connection with the property owners engaging in purchase transactions for installations of energy systems.

33. The method of claim 32 in which the online interface comprises a dashboard that gives to each of the installers access to information about the energy systems, the purchase transactions, and the property owners.

34. The method of claim 32 in which the online interface enables the potential installers to communicate with the property owners using text, images, video, or documents.

35. The method of claim 32 in which the online interface enables installers to reserve one of a limited number of potential opportunities to provide commercial offers with respect to a purchase transaction to be engaged in by a property owner.

36. The method of claim 32 in which the online interface enables installers to specify parameters of potential purchase transactions for which they wish to be notified for consideration.

37. The method of claim 32 in which the information includes marketing information of the installers.

38. The method of claim 32 in which the online interface enables installers to submit contracts for electronic signatures by the property owners.

39. The method of claim 32 in which the online interface is provided through a mobile application or a website.

40. A computer-implemented method comprising
providing an online interface in which a property owner enters information defining a specification of an intended energy system to be installed for the property owner,
the specification being in sufficient detail to enable each of two or more different installers to provide ready-for-acceptance commercial offers of an energy system that conforms to the specification.
through the online interface presenting to the property owner parameters defining the two or more ready-to-accept offers each to install an energy system that conforms to a common specification of an energy system, the parameters of the offers being expressed in common comparable units,
through the online interface, presenting to the property owner interactive tools that enable the property owner to compare or rank the two or more ready-to-accept offers each to install an energy system that conforms to a common specification previously expressed by the property owner, and
presenting to property owners in connection with the property owners engaging in purchase transactions for installations of energy systems, marketing information of installers that has been entered through a different online interface.

41. A computer-implemented method comprising
providing an online interface in which a property owner is presented with a guided sequence of interactive steps in each of which the property owner is prompted to enter information associated with energy systems that may be relevant to the property owner, the content of at least one of the later steps being dependent on the information entered by the user in a prior step.

42. The method of claim 41 in which the information to be entered comprises information associated with at least one of energy-related objectives of the property owner, a property of the property owner, an existing energy system, and an existing cost of energy.

43. The method of claim 42 in which the information to be entered by the property owner comprises information that bears on the suitability of the energy systems for the property owner or a property to be served by the energy system.

44. The method of claim 43 in which the energy systems comprise energy systems of at least two different classes or types.

45. The method of claim 43 in which the information to be entered by the property owner comprises characteristics of a property to be served by the energy systems.

46. The method of claim 43 in which the information to be entered by the property owner comprises characteristics of energy usage associated with the property owner or a property to be served by the energy systems.

47. The method of claim 43 in which the information to be entered by the property owner comprises characteristics of the energy systems.

48. The method of claim 43 in which the information to be entered by the property owner comprises characteristics of existing energy systems of the property owner.

49. The method of claim 43 in which the information to be entered by the property owner comprises information that represents criteria for selecting one or more energy systems from a set of energy systems.

50. The method of claim 43 comprising presenting to the property owner an indication of a technical feasibility of one or more energy systems for a property associated with the property owner based on the information entered by the property owner.

51. The method of claim 43 comprising presenting to the property owner an indication of a suitability of one or more energy systems for a property associated with the property owner based on the information entered by the property owner.

52. The method of claim 43 in which information provided by the property owner is used for online solicitation of commercial offers by installers for energy systems identified as technically feasible and suitable for a property associated with the property owner.

53. A computer-implemented method comprising
presenting to a property owner through an online interface results of a selection of energy systems from a set of possible energy systems based on technical feasibility and suitability as indicated by information provided by the property owner through the interface in response to a series of prompts the content of some of which depend on information provided with respect to prior prompts.
